(19) United States
(12) Patent Application Publication
(10) Pub. No.: US 2026/0132861 A1
(43) Pub. Date: May 14, 2026

(54) AIR VALVE, AIR VALVE ASSEMBLY, AND INFLATABLE PRODUCT

(71) Applicant: BESTWAY INFLATABLES & MATERIAL CORP., Shanghai (CN)

(72) Inventors: Xianglin ZENG, Shanghai (CN); Qingshui SONG, Shanghai (CN)

(21) Appl. No.: 19/327,118

(22) Filed: Sep. 12, 2025

(30) Foreign Application Priority Data
Nov. 8, 2024 (CN) 202422739573.8
Dec. 18, 2024 (CN) 202423136765.6

(51) Int. Cl. F16K 24/00

(52) U.S. Cl. CPC F16K 24/00

(57) ABSTRACT

An air valve includes a valve body, a valve seat connected to the valve body to form a fluid channel, a first sealing member arranged between the valve body and the valve seat, and a valve core including air vents in communication with the fluid channel. The valve core is rotatably arranged in the fluid channel relative to the valve seat and is surrounded by the first sealing member, so as to switch the valve core between a first position and a second position. In the first position, the valve core is in contact with an inner wall of the fluid channel, and the first sealing member is in contact with the valve core and seals the valve core against the inner wall of the fluid channel. In the second position, the valve core is spaced apart from the inner wall of the fluid channel, and the first sealing member surrounds the valve core and is spaced apart from the valve core.

### CROSS-REFERENCE TO RELATED APPLICATIONS

The present disclosure claims priority to Chinese Patent Application No. 202422739573.8, filed with the China National Intellectual Property Administration on November 08, 2024 and entitled "AIR VALVE", and Chinese Patent Application No. 202423136765.6, filed with the China National Intellectual Property Administration on December 18, 2024 and entitled “AIR VALVE”, each of which are incorporated herein by reference in their entireties.

### TECHNICAL FIELD

The present disclosure relates to air passage devices, and in particular, to an air valve, an air valve assembly, and an inflatable product.

### BACKGROUND

The improvement of individual quality of life has coincided with increased demands for inflatable products, in particular inflatable mattresses and inflatable sponge mattresses. In order to prevent a user from having to replenish the inflatable product with air multiple times during use, the demand for air valves with good sealing performance, which can be applied to an inflatable mattress has similarly increased

Although traditional air valves may seal an inflatable product and can be connected to an air pump for inflating the inflatable product, many air valves offer poor sealing performance. Moreover, when the inflatable product is deflated, air flows back into the inflatable product, resulting in the inability to completely discharge the air inside the inflatable mattress. As a result, the user needs a large space to store the inflatable product when the product is not used.

### SUMMARY

The present disclosure aims to solve the problem of poor sealing performance of existing air valves. The present disclosure provides an air valve, an air valve assembly, and an inflatable product, which can stabilize a sealing effect.

In order to solve the above-described technical problem, an implementation of the present disclosure discloses an air valve, including: a valve body; a valve seat connected to the valve body to form a fluid channel; a first sealing member arranged between the valve body and the valve seat; and a valve core including air vents in communication with the fluid channel, the valve core being rotatably arranged in the fluid channel relative to the valve seat and being surrounded by the first sealing member, so as to switch the valve core between a first position and a second position, wherein the first position, the valve core is in contact with an inner wall of the fluid channel, and the first sealing member is in contact with the valve core and seals the valve core against the inner wall of the fluid channel; and in the second position, the valve core is spaced apart from the inner wall of the fluid channel, and the first sealing member surrounds the valve core and is spaced apart from the valve core.

In some embodiments, the valve body is connected to the valve seat to form the fluid channel, and the valve core includes the air vents and is in communication with the fluid channel, such that in the first position, the valve core is in contact with the inner wall of the fluid channel, the air vents are in communication with the fluid channel to allow an outside fluid to flow in the fluid channel, and the first sealing member also seals a gap between the valve core and the inner wall of the fluid channel, preventing the fluid from flowing into or out of the gap between the valve core and the inner wall of the fluid channel, and thus ensuring a sealing effect. Moreover, the first sealing member surrounds the valve core and is located between the valve body and the valve seat, which can stabilize the first sealing member, thereby preventing the first sealing member from falling off, which would otherwise cause sealing failure and affect a flow track of the fluid.

In the second position, the valve core is spaced apart from the inner wall of the fluid channel, and the first sealing member surrounds the valve core and is spaced apart from the valve core. In this case, the fluid channel is not blocked by the valve core so that the fluid channel opens and is in a maximum fluid-flow state, facilitating the inflow or outflow of the fluid and enabling the rapid inflow and outflow of the fluid. During switching of the valve core from the first position to the second position, a user may rotate the valve core to change the size of an opening of the fluid channel, thus adjusting an inflation/deflation speed.

According to another embodiment of the present disclosure, at least one rib is provided on a side of the first sealing member facing the valve core, and the at least one rib is spaced apart in a circumferential direction, where in the first position, the at least one rib abuts against the valve core; and in the second position, the at least one rib surrounds the valve core and is spaced apart from the valve core.

In some embodiments, in the first position, a plurality of ribs abut against the valve core, so that a friction force between the first sealing member and the valve core can be reduced, facilitating the rotation of the valve core in the fluid channel, and thus facilitating the switching of the valve core between the first position and the second position.

In some embodiments, the valve core is capable of 360-degree omnidirectional rotation within the fluid channel, enabling unrestricted multi-axis movement centered at a central axis of the valve core.

According to another embodiment of the present disclosure, an inner wall of the valve body protrudes to form a first connecting portion, and the valve seat includes a first main body portion, where the first main body portion is internally hollow and is connected to the valve body to form the fluid channel, the first main body portion extends in an axial direction, such that the first main body portion and the first connecting portion are arranged opposite each other and spaced apart in the axial direction and form an accommodating space together with the inner wall of the valve body, and the first sealing member is located in the accommodating space.

According to another embodiment of the present disclosure, a hook is provided at a top end of the inner wall of the valve body in the axial direction, the hook and the first connecting portion are spaced apart in the axial direction, a mounting portion is provided on an outer wall of the first main body portion, and the mounting portion is configured for connection to the hook in a snap-fit manner to connect the valve seat to the valve body and clamp the first sealing member in the accommodating space.

In these embodiments, the valve body and the valve seat are connected together by means of a hook-fastening structure of a hook and the mounting portion, so that the first sealing member can be clamped in the accommodating space, preventing the first sealing member from falling off, which would otherwise affect the sealing effect.

According to another embodiment of the present disclosure, an outer periphery of the first main body portion protrudes outwardly to form a first abutting portion, and the first abutting portion is configured for connection to the inflatable main body.

According to another embodiment of the present disclosure, the first abutting portion is annular.

According to another embodiment of the present disclosure, an outer periphery of the first main body portion protrudes outwardly to form a second abutting portion, the second abutting portion axially extends in a direction close to the valve body and is spaced apart from the first main body portion in a radial direction to form an annular groove, and the annular groove is configured to accommodate the valve body and is in threaded fit with an outer wall of the valve body to clamp the first sealing member in the accommodating space.

In these embodiments, the valve body and the valve seat are connected by means of threads, so that the first sealing member can be clamped in the accommodating space, preventing the first sealing member from falling off, which would otherwise affect the sealing effect.

According to another embodiment of the present disclosure, a projection of the second abutting portion in the axial direction includes a first straight segment, a first circular arc segment, a second straight segment, a third straight segment, a second circular arc segment and a fourth straight segment that are connected to each other.

According to another embodiment of the present disclosure, a plurality of supports are provided on a side of the valve body away from the valve seat, the plurality of supports are spaced apart in a circumferential direction to form a plurality of air outlet through holes, and the plurality of air outlet through holes are in communication with the fluid channel.

According to another embodiment of the present disclosure, eight supports are provided, one end of each of the supports extends toward the valve seat and is connected to the first connecting portion, the other end thereof is connected by means of a second connecting portion, and the second connecting portion is located at a bottom end of the valve body.

According to another embodiment of the present disclosure, the air valve further includes a valve cap, the valve cap being threadedly connected to the valve seat.

According to another embodiment of the present disclosure, the valve cap includes a first portion and a second portion, the first portion and the second portion being spaced apart in a radial direction to form a connecting groove, and the connecting groove being configured to accommodate the valve seat and being threadedly connected to the valve seat.

According to another embodiment of the present disclosure, the first portion is internally hollow and is in communication with the fluid channel, a plurality of reinforcing ribs are provided inside the first portion, and the plurality of reinforcing ribs are spaced apart in a circumferential direction.

In these embodiments, the provision of the reinforcing ribs can enhance the stiffness of the valve cap, improving the sealing effect of the air valve after the valve cap and valve seat are connected.

According to another embodiment of the present disclosure, a second sealing member is provided in the connecting groove to enable a sealed connection between the valve cap and the valve seat.

According to another embodiment of the present disclosure, the valve core is provided with a plurality of baffle plates, the plurality of baffle plates are spaced apart in a circumferential direction to form the air vent, one end of each of the plurality of baffle plates is connected to an inner wall of the valve core, and the other end thereof is connected to a third connecting portion.

According to another embodiment of the present disclosure, each of the baffle plates is straight, or each of the baffle plates is arc-shaped.

According to another embodiment of the present disclosure, at least a part of an inner wall of each air vent is provided with a stopper, and the stopper extends toward the air vent.

According to another embodiment of the present disclosure, the stopper is an annular block, one side of the stopper is connected to the inner wall of the air vent, and the other side thereof extends toward the air vent.

According to another embodiment of the present disclosure, a plurality of stoppers are provided, and the plurality of stoppers are spaced apart in the circumferential direction.

According to another embodiment of the present disclosure, the stopper is arranged at the bottom, middle or top of the inner wall of the air vent in an axial direction.

According to another embodiment of the present disclosure, the stopper is integrally formed with the valve core.

According to another embodiment of the present disclosure, the stopper extends toward a through hole with a length of 1.5 mm to 4 mm and extends in the circumferential direction with a width of 1.5 mm to 4 mm.

According to another embodiment of the present disclosure, the air valve further includes a valve diaphragm, where the valve diaphragm is located on a side of the valve core facing the valve body, and the valve diaphragm is connected to the valve core by means of a connecting rod and covers the air vents.

According to another embodiment of the present disclosure, the third connecting portion is provided with a through hole, and the connecting rod passes through the through hole and is connected to the valve core.

According to another embodiment of the present disclosure, the valve seat has an outer diameter of 40 mm to 120 mm, the valve body has an outer diameter of 30 mm to 110 mm, the valve diaphragm has an outer diameter of 18 mm to 108 mm, and the valve core has an outer diameter of 20 mm to 100 mm.

According to another embodiment of the present disclosure, the valve core has an inner diameter of 16 mm to 96 mm, the valve core has a thickness of greater than 3 mm, and the valve diaphragm has a thickness of 0.5 mm to 10 mm.

According to another embodiment of the present disclosure, a force for turning the valve core to rotate relative to the valve seat is less than 0.5 N.

An implementation of the present disclosure further discloses an air valve, including: a valve body; a valve seat connected to the valve body to form a fluid channel; a valve core including air vents, the valve core being located in the fluid channel, the air vents being in communication with the fluid channel, and the valve core being rotatably connected to the fluid channel to switch the valve core between a first position and a second position; and a first sealing member surrounding the valve core and integrally formed with the valve core, where in the first position, the valve core is in contact with an inner wall of the fluid channel, and the first sealing member is in contact with the inner wall of the fluid channel and seals the valve core against the inner wall of the fluid channel; and in the second position, the valve core is spaced apart from the inner wall of the fluid channel, and the first sealing member is spaced apart from the inner wall of the fluid channel.

In these embodiments, the valve body is connected to the valve seat to form the fluid channel, and the valve core includes the air vents and is in communication with the fluid channel, such that in the first position, the valve core is in contact with the inner wall of the fluid channel, the air vents are in communication with the fluid channel to allow an outside fluid to flow in the fluid channel, and the first sealing member also seals a gap between the valve core and the inner wall of the fluid channel, preventing the fluid from flowing into or out of the gap between the valve core and the inner wall of the fluid channel, and thus ensuring a sealing effect. Moreover, the first sealing member is integrally formed with the valve core, so that the first sealing member can be stably arranged on the valve core, thereby preventing the first sealing member from falling off, which would otherwise cause sealing failure and affect a flow track of the fluid.

In the second position, the valve core is spaced apart from the inner wall of the fluid channel, and the first sealing member is spaced apart from the inner wall of the fluid channel. In this case, the fluid channel is not blocked by the valve core so that the fluid channel opens and is in a maximum fluid-flow state, facilitating the inflow or outflow of the fluid and enabling the rapid inflow and outflow of the fluid. During switching of the valve core from the first position to the second position, a user may rotate the valve core to change the size of an opening of the fluid channel, thus adjusting an inflation/deflation speed.

According to another embodiment of the present disclosure, at least one rib is provided on a side of the first sealing member facing the fluid channel, and the at least one rib is spaced apart in a circumferential direction, where in the first position, the at least one rib abuts against the inner wall of the fluid channel; and in the second position, the at least one rib is spaced apart from the inner wall of the fluid channel.

In these embodiments, in the first position, the at least one rib abuts against the inner wall of the fluid channel, so that a friction force between the first sealing member and the inner wall of the fluid channel can be reduced, facilitating the rotation of the valve core in the fluid channel, and thus facilitating the switching of the valve core between the first position and the second position.

An implementation of the present disclosure further discloses an air valve assembly, including: an air valve of any one of the implementations as described above; and a connector having a second channel for a fluid to pass through, the fluid channel being in communication with the second channel, one end of the connector being connected to the valve seat, and the other end thereof being configured for connection to an external apparatus.

According to another embodiment of the present disclosure, the connector includes a connector body, where the connector body extends in an axial direction, and the connector body is internally hollow to form the second channel; and the connector body includes a first end and a second end that are arranged opposite each other in the axial direction, the first end being provided with a recess for abutting against the external apparatus, and the second end being provided with a thread and being threadedly connected to the valve seat.

According to another specific implementation of the present disclosure, the implementation of the present disclosure discloses an air valve assembly, where a protruding portion is provided on a side wall of the connector body close to the second end, and the protruding portion surrounds the side wall of the connector body and is located at the top of the valve seat.

According to another specific implementation of the present disclosure, the implementation of the present disclosure discloses an air valve assembly, where the connector includes a connector body and a protruding portion, where the connector body extends in an axial direction, and the connector body is internally hollow to form the second channel; the connector body includes a first end and a second end that are arranged opposite each other in the axial direction, the first end being configured for connection to the external apparatus to insert the external apparatus into the second channel, and the second end being provided with a thread and being threadedly connected to the valve seat; and the protruding portion surrounds an outer periphery of the first end and is located at the top of the valve seat.

An implementation of the present disclosure further discloses an inflatable product, including: an inflatable main body including an inflatable chamber; and an air valve of any one of the implementations as described above, the valve seat being connected to the inflatable main body such that the valve body is located in the inflatable chamber.

### BRIEF DESCRIPTION OF THE DRAWINGS

Other features and advantages of the present disclosure will be understood from the following embodiments described in detail herein and with reference to the accompanying drawings, in which like reference numerals represent the same or similar components.

FIG. 1 shows a schematic diagram of an inflatable product, according to one or more embodiments shown and described herein;

FIG. 1A shows a schematic diagram of an inflatable main body, according to one or more embodiments shown and described herein;

FIG. 1B shows a schematic diagram of an inflatable main body, according to one or more embodiments shown and described herein;

FIG. 1C shows a schematic diagram of an inflatable main body, according to one or more embodiments shown and described herein;

FIG. 1D shows a schematic diagram of an inflatable main body, according to one or more embodiments shown and described herein;

FIG. 1E shows a schematic diagram of an inflatable main body, according to one or more embodiments shown and described herein;

FIG. 2 shows a perspective view of an air valve of the inflatable product of FIG. 1A, according to one or more embodiments shown and described herein;

FIG. 3 shows a cross-sectional view of the air valve of FIG. 2, according to one or more embodiments shown and described herein;

FIG. 4 shows an exploded view of the air valve of FIG. 2, according to one or more embodiments shown and described herein;

FIG. 5 shows a perspective view of a valve cap of the air valve of FIG. 2 in an open state, according to one or more embodiments shown and described herein;

FIG. 6A shows a schematic view of the air valve of FIG. 2, according to one or more embodiments shown and described herein;

FIG. 6B shows a perspective view of a valve seat of the air valve of FIG. 2, according to one or more embodiments shown and described herein;

FIG. 6C shows a perspective view of the valve seat of FIG. 2 or 6A, according to one or more embodiments shown and described herein;

FIG. 7 shows a schematic diagram of the air valve of FIG. 2 in a first position, according to one or more embodiments shown and described herein;

FIG. 7A shows a perspective view of a first type of connector, according to one or more embodiments shown and described herein;

FIG. 7B shows a cross-sectional view of a first type of air valve assembly, according to one or more embodiments shown and described herein;

FIG. 7C shows a perspective view of a second type of connector, according to one or more embodiments shown and described herein;

FIG. 7D shows a cross-sectional view of a second type of air valve assembly, according to one or more embodiments shown and described herein

FIG. 8 shows a schematic diagram of an air valve in a first position, according to one or more embodiments shown and described herein;

FIG. 9 shows a schematic diagram of an air valve in a second position, according to one or more embodiments shown and described herein;

FIG. 10A shows a schematic cross-sectional view of an air valve, according to one or more embodiments shown and described herein;

FIG. 10B shows a schematic diagram of a valve core of the air valve of FIG. 10A, according to one or more embodiments shown and described herein

FIG. 11 shows a schematic cross-sectional view of an air valve, according to one or more embodiments shown and described herein;

FIG. 12 shows a perspective view of an air valve, according to one or more embodiments shown and described herein

FIG. 13 shows a schematic cross-sectional view of an air valve, according to one or more embodiments shown and described herein;

FIG. 14 shows a schematic cross-sectional view of an air valve, according to one or more embodiments shown and described herein;

FIG. 15 shows a schematic cross-sectional view of an air valve, according to one or more embodiments shown and described herein;

FIG. 16 shows a schematic cross-sectional view of an air valve, according to one or more embodiments shown and described herein;

FIG. 17 shows a schematic diagram of a valve core, according to one or more embodiments shown and described herein;

FIG. 18 shows a schematic diagram of a valve core, according to one or more embodiments shown and described herein;

FIG. 19 shows a schematic diagram of a valve core showing air vents of the valve core being divided into a fan shape, according to one or more embodiments shown and described herein

FIG. 20 shows a schematic diagram of a valve core showing a baffle plate being arc-shaped, according to one or more embodiments shown and described herein; and

FIG. 21 shows a schematic cross-sectional view of the air valve shown in FIG. 5 with the valve cap removed, according to one or more embodiments shown and described herein.

### DETAILED DESCRIPTION

Embodiments of the present disclosure are illustrated below, and those skilled in the art may readily understand advantages and effects of the present disclosure from the content disclosed in the description. Although the description of the present disclosure will be introduced in conjunction with preferred embodiments, it does not mean that features of the present disclosure are limited to the implementations described herein. On the contrary, an objective of introducing the present disclosure in conjunction with the embodiments described herein is to encompass other options or modifications that may be extended on the basis of the claims of the present disclosure. The following description contains numerous specific details in order to provide deep understanding of the present disclosure. The present disclosure may also be implemented without these details. In addition, in order to avoid confusion of the present disclosure, some specific details will be omitted in the description. It should be noted that the embodiments and the features thereof in the present disclosure can be combined with each other without conflicts.

In the description of the present disclosure, it should be understood that orientation or position relationships indicated by terms such as “center”, “longitudinal”, “transverse”, “length”, “width”, “thickness”, “up”, “down”, “front”, “rear”, “left”, “right”, “vertical”, “horizontal”, “top”, “bottom”, “inside”, “outside”, “clockwise”, and “anticlockwise” are based on orientation or position relationships shown in the accompanying drawings and are merely for ease of description of the present disclosure and simplification of the description, rather than indicating or implying that the apparatuses or elements referred to must have a specific orientation or be constructed and operated in a specific orientation, and therefore cannot be construed as limiting the present disclosure.

In addition, terms “first”, “second”, etc. are merely for the purpose of description, and should not be construed as indicating or implying the relative importance or implicitly indicating the number of technical features indicated. Thus, the features defined with “first” and “second” may explicitly or implicitly include one or more features. In the description of the present disclosure, the meaning of “a plurality of” is two or more, unless specifically defined otherwise.

In the present disclosure, it should also be noted that the terms “arrange”, “connected”, and “connection” should be understood in a broad sense, unless otherwise explicitly specified and limited. For example, the connection may be a secured connection, a detachable connection, or an integral connection; or may be a mechanical connection or an electrical connection; or may be a direct connection, an indirect connection by means of an intermediate medium, or internal communication between two elements. For those of ordinary skill in the art, the specific meaning of the terms mentioned above in the embodiments should be understood in specific cases.

In the present disclosure, unless otherwise explicitly specified and defined, the first feature being “above” or “below” the second feature may include the first and second features being in direct contact, or may include the first and second features being not in direct contact but coming into contact through another feature between them. In addition, the first feature being “above”, “over”, and “on” the second feature includes the first feature being directly above and obliquely above the second feature, or simply means that the level of the first feature is higher than that of the second feature. The first feature being "below", "beneath", and "on underside of" the second feature includes the first feature being directly below and obliquely below the second feature, or simply means that the level of the first feature is less than that of the second feature.

In the description of the present disclosure, the meaning of “a plurality of” is two or more, unless specifically defined otherwise.

To make the objectives, technical solutions, and advantages of the present disclosure clearer, the technical solutions of the present disclosure will be clearly and completely described with reference to specific embodiments of the present disclosure and corresponding figures.

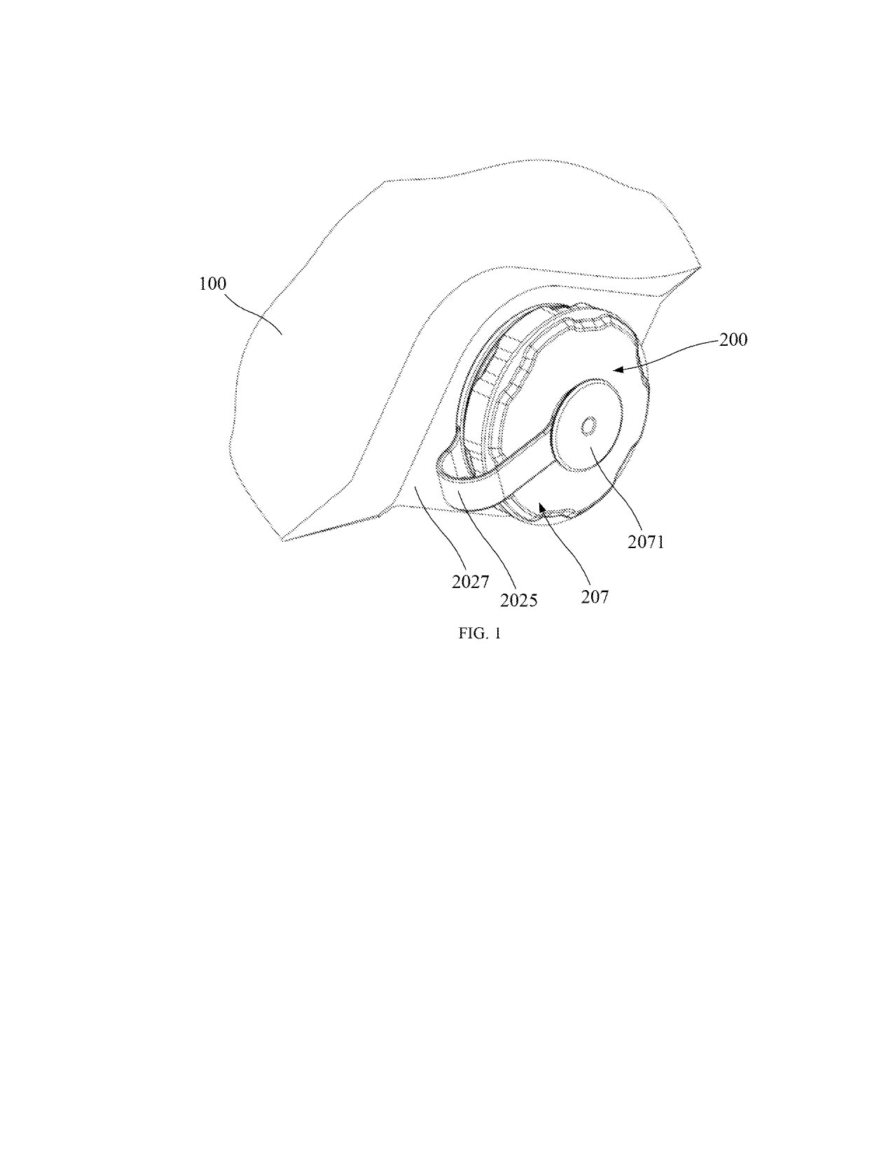

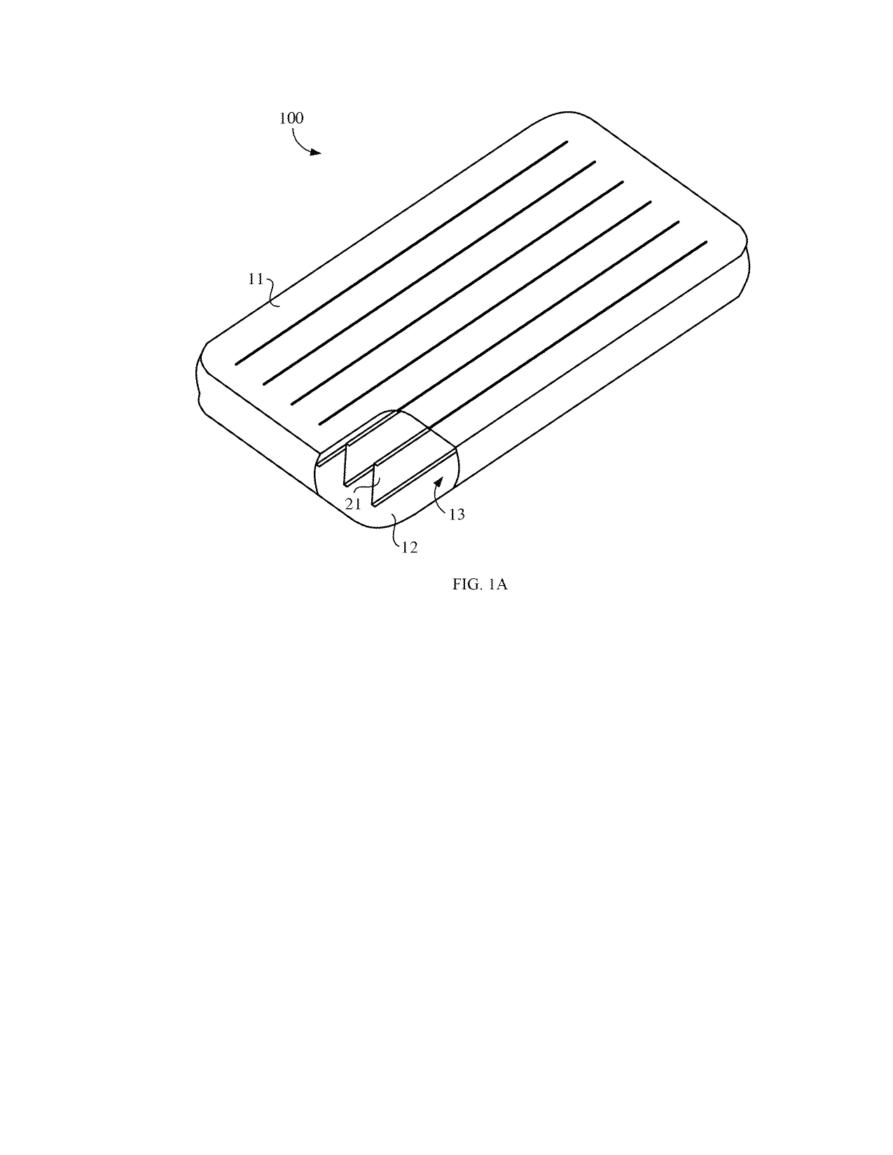

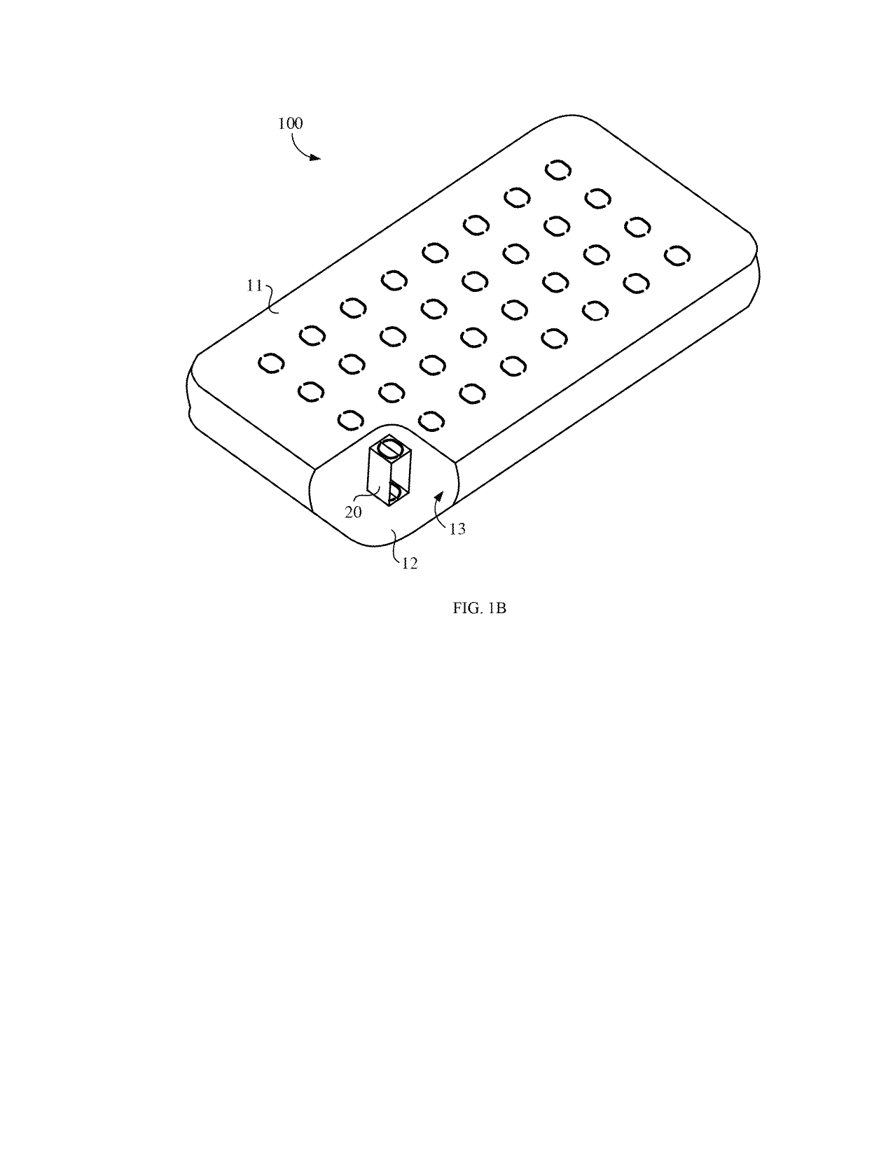

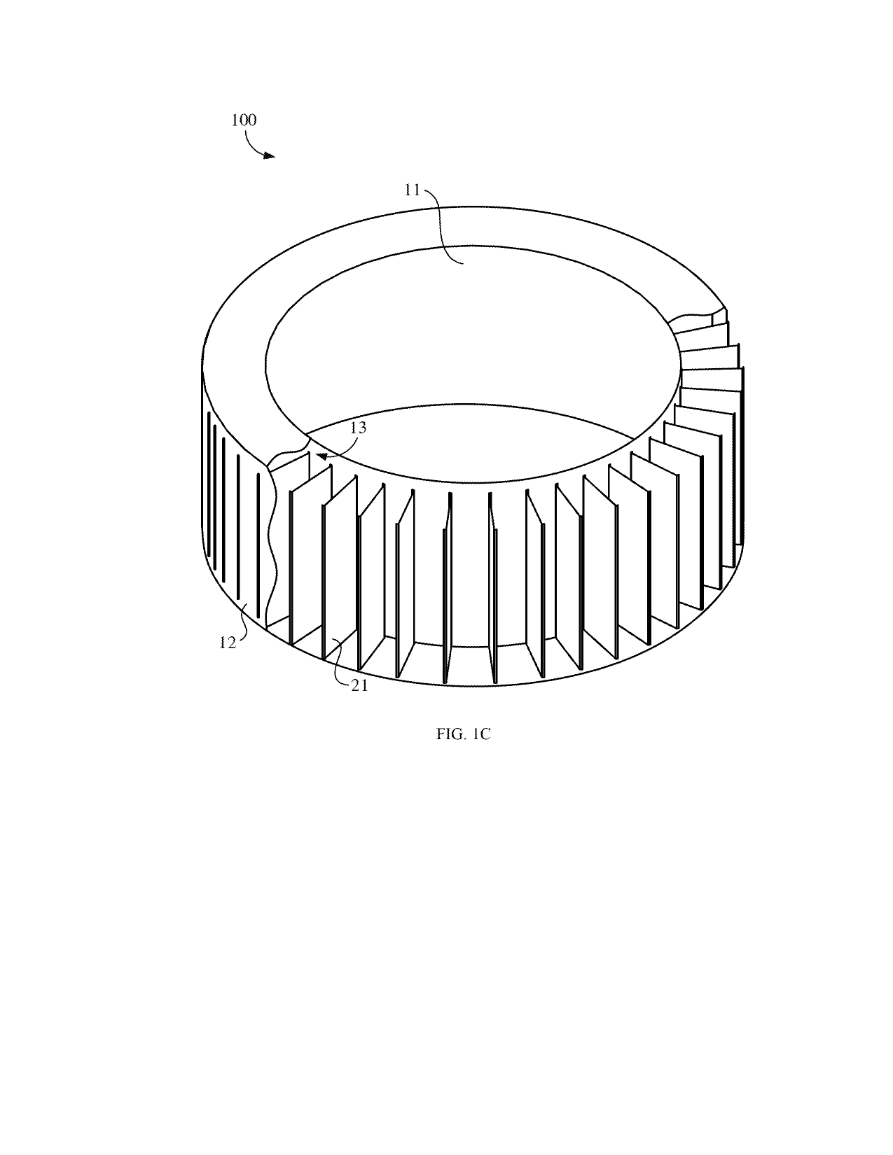

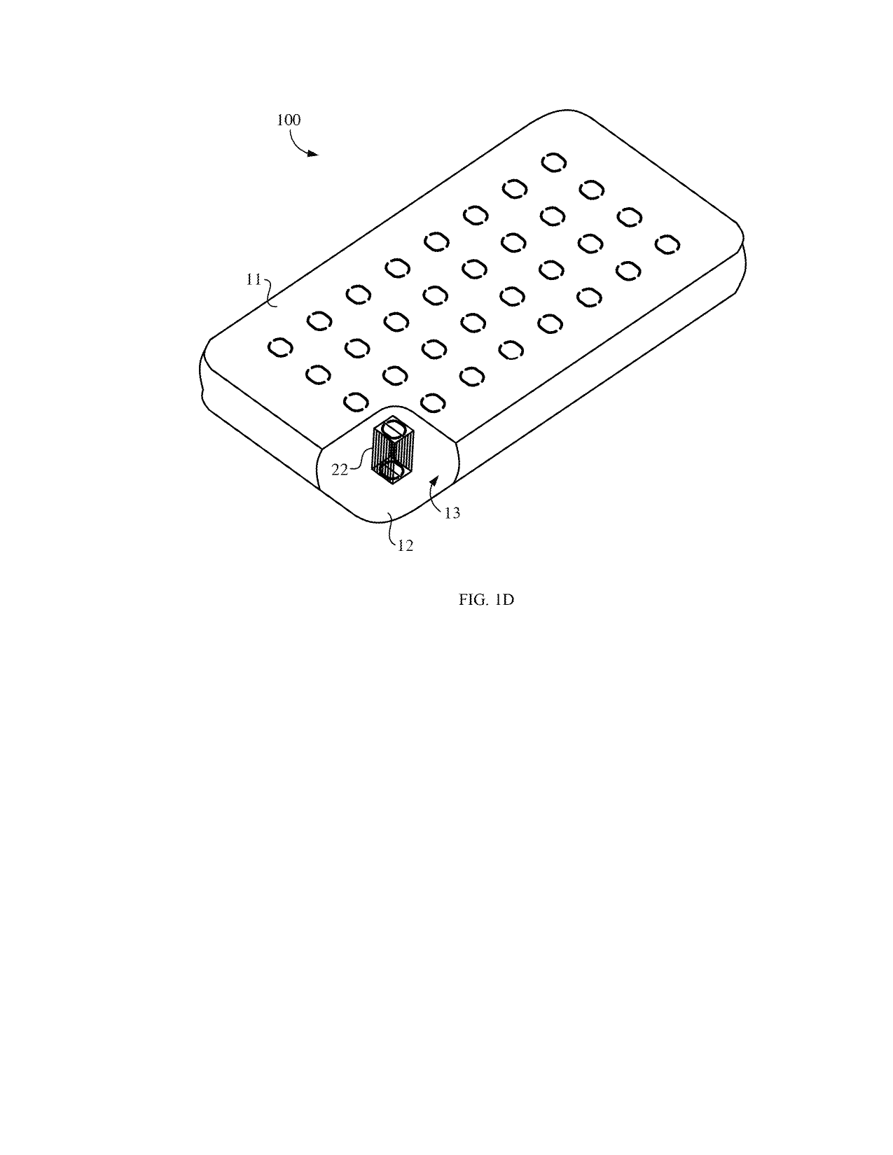

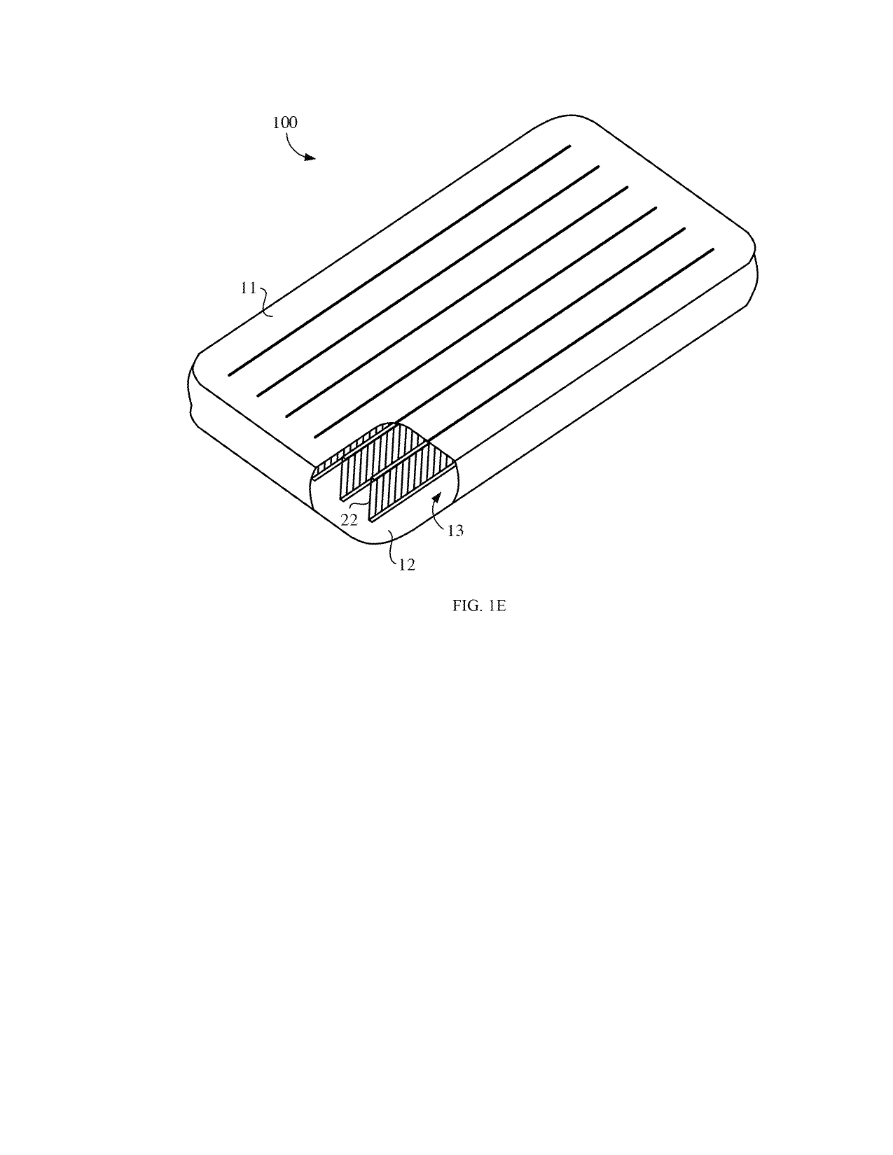

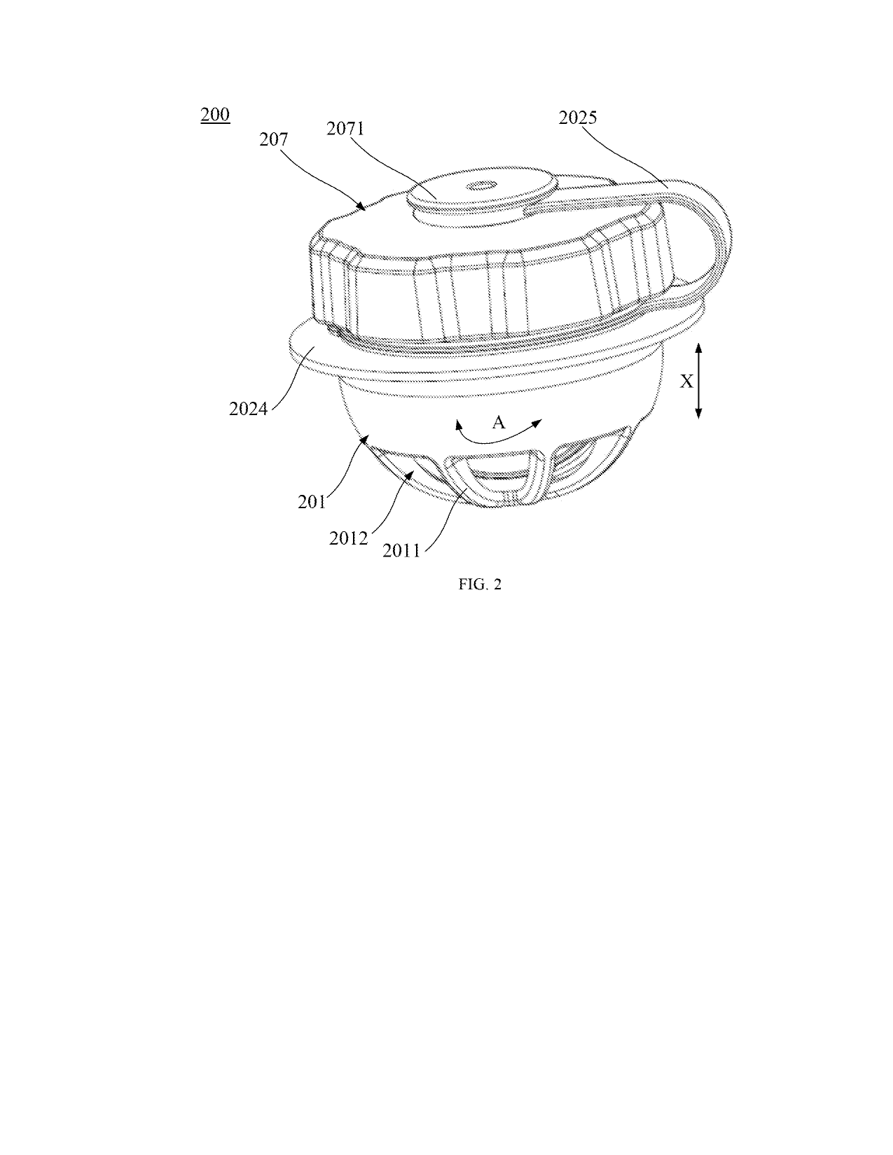

The embodiments of the present disclosure provide an inflatable product. As illustrated in FIG. 1, the inflatable product may include an air valve 200. Furthermore, the air valve 200 of FIG. 1 may be applied to an inflatable mattress or a TPU inflatable sponge mattress, as will be described in additional detail herein.

Referring to FIGS. 1A to 1E, a plurality of inflatable products are depicted. In these embodiments, each of the inflatable products may include an inflatable main body 100 having at least one first wall 11, a second wall 12, and an inflatable chamber 13 defined by the first wall 11 and the second wall 12 and configured for inflation. In these embodiments, after the pressure of gas (e.g., air, etc.) in the inflatable chamber 13 reaches a desired value, the inflatable main body 100 may be in an inflated state and may retain a preset shape. Conversely, when and after the air in the inflatable chamber 13 is discharged, the inflatable main body 100 may be in a deflated state, such that a volume of the inflatable main body 100 is greatly reduced relative to the volume thereof in the inflated state, thereby facilitating the storage of the inflatable main body 100.

Referring still to FIGS. 1A-1E, a plurality of tensioning members 20 may be provided in the inflatable chamber 13 of the inflatable main body 100, and the tensioning members 20 may be connected to the first wall 11 and the second wall 12 by high-frequency welding, hot melting, adhesive bonding or other connection means. The tensioning members 20, after being tensioned, may provide a tensile force to the first wall 11 and the second wall 12 to limit the deformation of the inflatable main body 100, such that the inflatable main body 100 can remain in the preset shape after being inflated.

In some embodiments, the plurality of tensioning members 20 have different structures in different embodiments. For example, in the embodiments depicted in FIGS. 1A-1E, each tensioning member 20 may be a sheet-like tensioning member 21 or a string-like tensioning member 22. However, it should be appreciated that the plurality of tensioning members 20 described herein may take any structural shape without departing from the scope of the present disclosure.

Referring still to FIGS. 1A-1E, the sheet-like tensioning member 21 may have a single-layer structure or a composite layer structure. In embodiments in which the sheet-like tensioning member 21 is a single-layer sheet material, the sheet-like tensioning member 21 may be made of a polymer material. The polymer material may include, but is not limited to, one or more of polyvinyl chloride (PVC), polyurethane (PU), thermoplastic urethanes (TPU), polyethylene terephthalate (PET), ethylene-vinyl acetate (EVA) copolymer and nylon. It should be further understood that, in these embodiments, a main body part of the single-layer sheet-like tensioning member 21 may be made of materials other than the polymer material, such as a fabric material. For example, in embodiments in which the fabric material is utilized, the fabric material may be finely woven or made to form a mesh-like structure. The fabric material may be, but is not limited to, a natural fiber fabric (e.g., but not limited to, a cotton fabric, a linen fabric, a wool fabric and a silk fabric) or a synthetic fiber fabric (e.g., but not limited to, a polyester fiber fabric, a polyethylene fiber fabric, and a polypropylene fiber fabric). However, it should be appreciated that the single-layer sheet material of the sheet-like tensioning member 21 may include material without departing from the scope of the present disclosure.

Referring still to FIGS. 1A-1E, in embodiments in which the sheet-like tensioning member 21 is a composite sheet material, the sheet-like tensioning member 21 may be composed of two or more layers of sheet materials bonded together by adhesive bonding, welding or other means, and each layer of the multi-layer sheet material may be made of the polymer material described above or the other materials described above.

Furthermore, the string-like tensioning member 22 may include one or more string bodies, which may span a distance between the first wall 11 and the second wall 12 of the inflatable main body 100 and may be parallel (or substantially parallel) in space. For example, in these embodiments, the one or more string bodies of the string-like tensioning members 22 may be spaced apart from each other in such a way that a distance between each of the one or more string bodies are equal. However, in other embodiments, the distance between each of the one or more string bodies may vary between each adjacent string body of the one or more string bodies according to a certain regularity (e.g., pattern, etc.)..

In the embodiments described herein, the material of the one or more string bodies in the string-like tensioning member 22 may be, but is not limited to, a natural fiber (e.g., but not limited to, a cotton fiber, a linen fiber, a wool fiber, and a silk fiber) or a synthetic fiber (e.g., but not limited to, a polyester fiber, a polyethylene fiber, and a polypropylene fiber). The string-like tensioning member 22 is generally indirectly connected to the first wall 11 and the second wall 12 via a connector. The connector may be made of, but is not limited to, a polymer material that facilitates welding of the first wall 11 and the second wall 12.

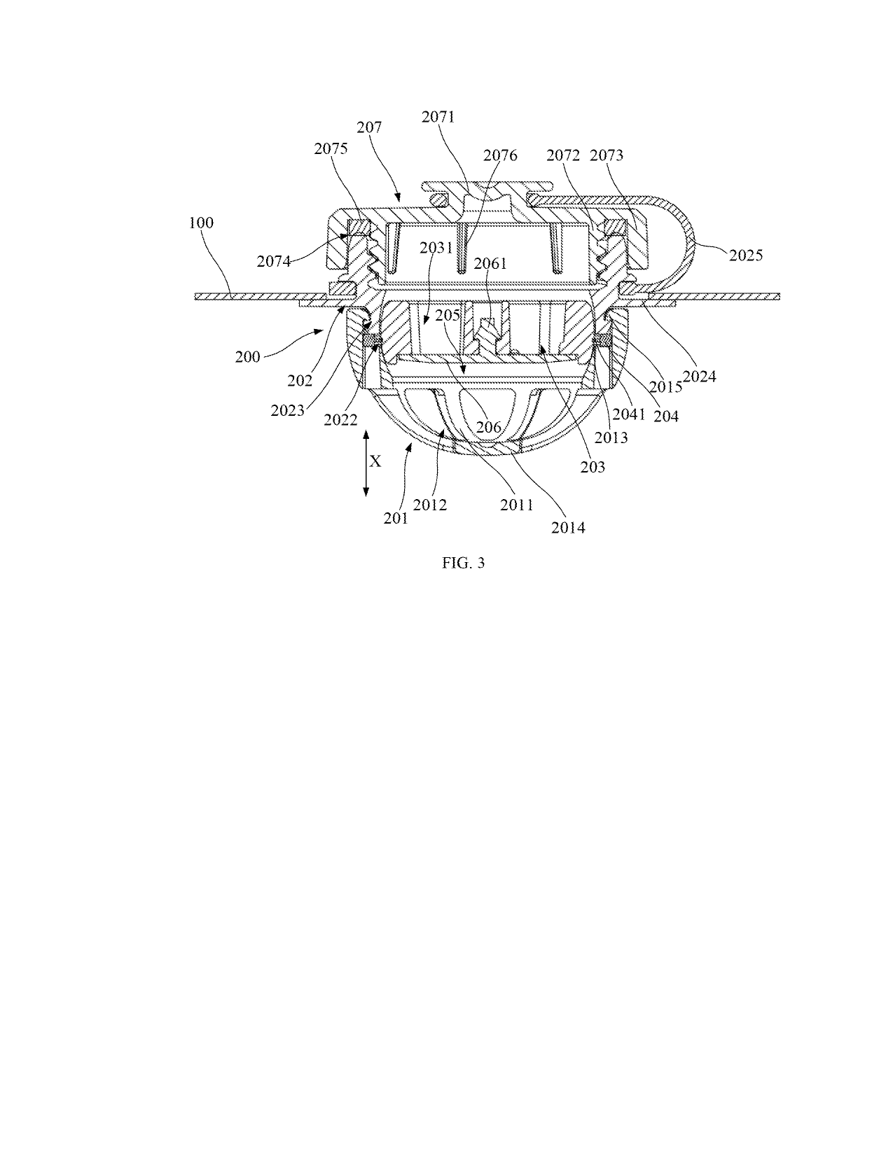

As noted hereinabove, it should be further appreciated that the air valve 200 may also be applied to the inflatable mattress or the TPU inflatable sponge mattress, as will be described in additional detail with reference to FIG. 3.

As an example, referring to FIGS. 1 - 2, an inflatable product in an embodiment of the present disclosure may include the air valve 200 and the inflatable main body 100 as described in any one of the following embodiments. The inflatable main body 100 includes the inflatable chamber 13. A valve seat 202 of the air valve 200 may be connected to the inflatable main body 100 such that a valve body 201 of the air valve 200 is located in the inflatable chamber 13.

As an example, the inflatable product is, for example, the inflatable mattress or the thermoplastic polyurethane (TPU) inflatable sponge mattress. A structure of the air valve 200 will be described in detail below in conjunction with the drawings.

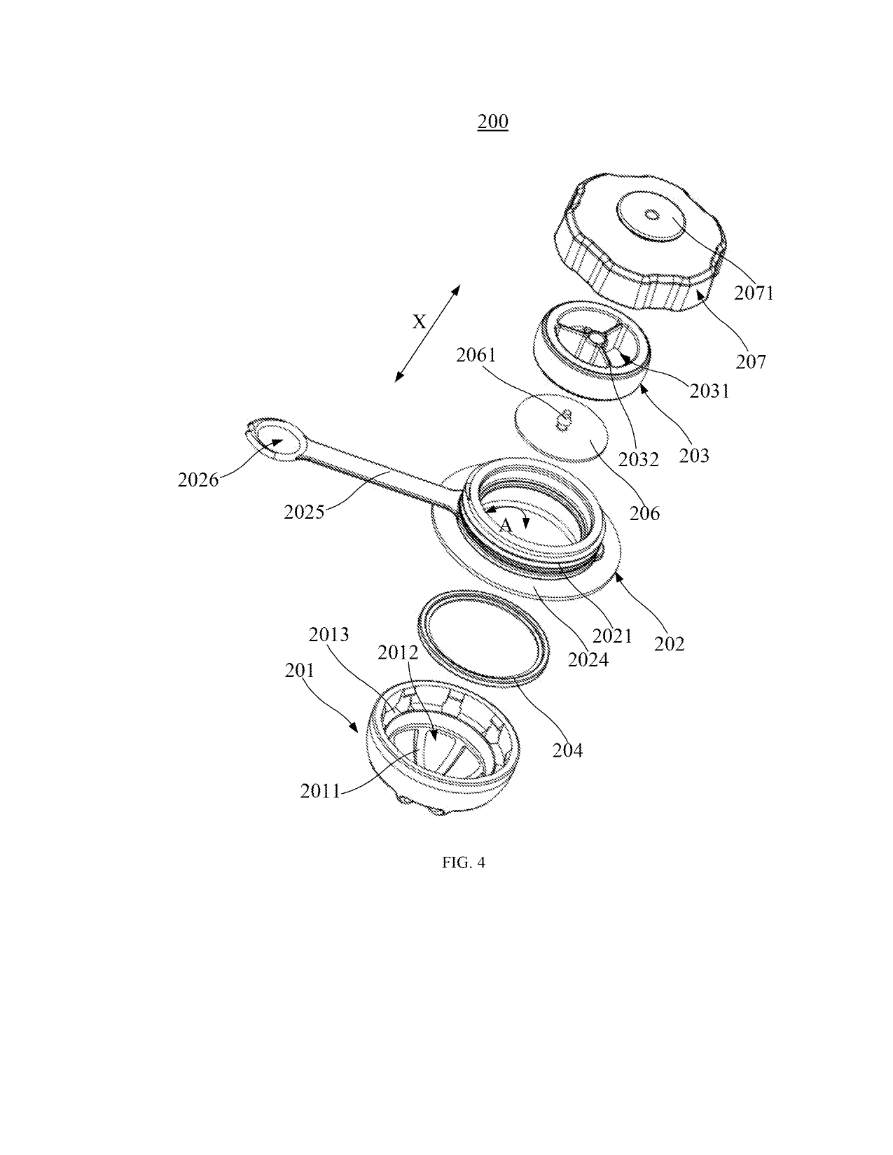

Referring now to FIGS. 3 and 4, the air valve 200 is depicted in additional detail. In these embodiments, the valve seat 202 of the air valve 200 may be made of a material which is suitable for high frequency, such as polyvinyl chloride (PVC), thermoplastic polyurethane (TPU) or polyethylene vinyl acetate (PEVA). Furthermore, a valve core 203 of the air valve 200 may be made of a material providing self-lubrication, such as polyoxymethylene (POM) or polytetrafluoroethylene (PTFE). It should be further understood that, in these embodiments, an valve cap 207 of the air valve 200 and the valve body 201 may be made of a material which has high strength and degree of finish, such as acrylonitrile butadiene styrene copolymer (ABS), polycarbonate (PC), poly (methyl methacrylate) (PMMA) or polypropylene (PP).

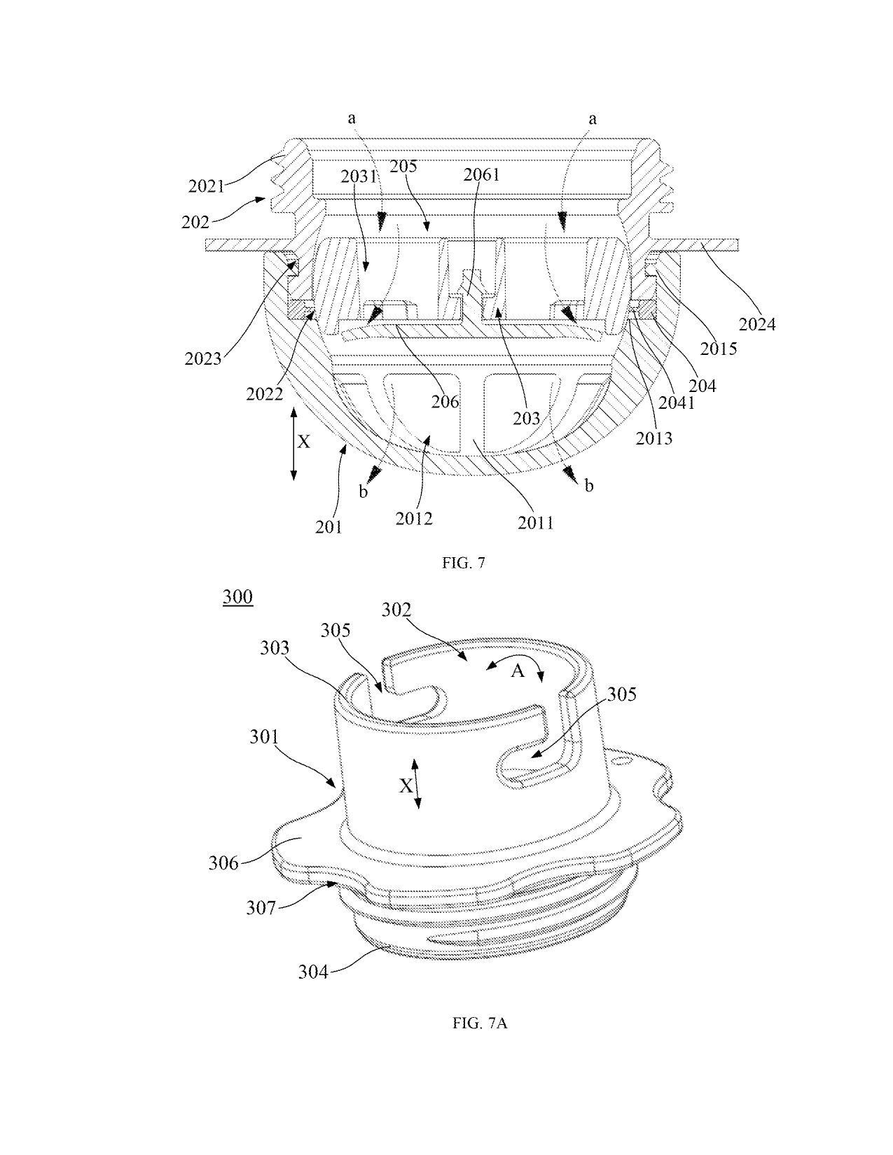

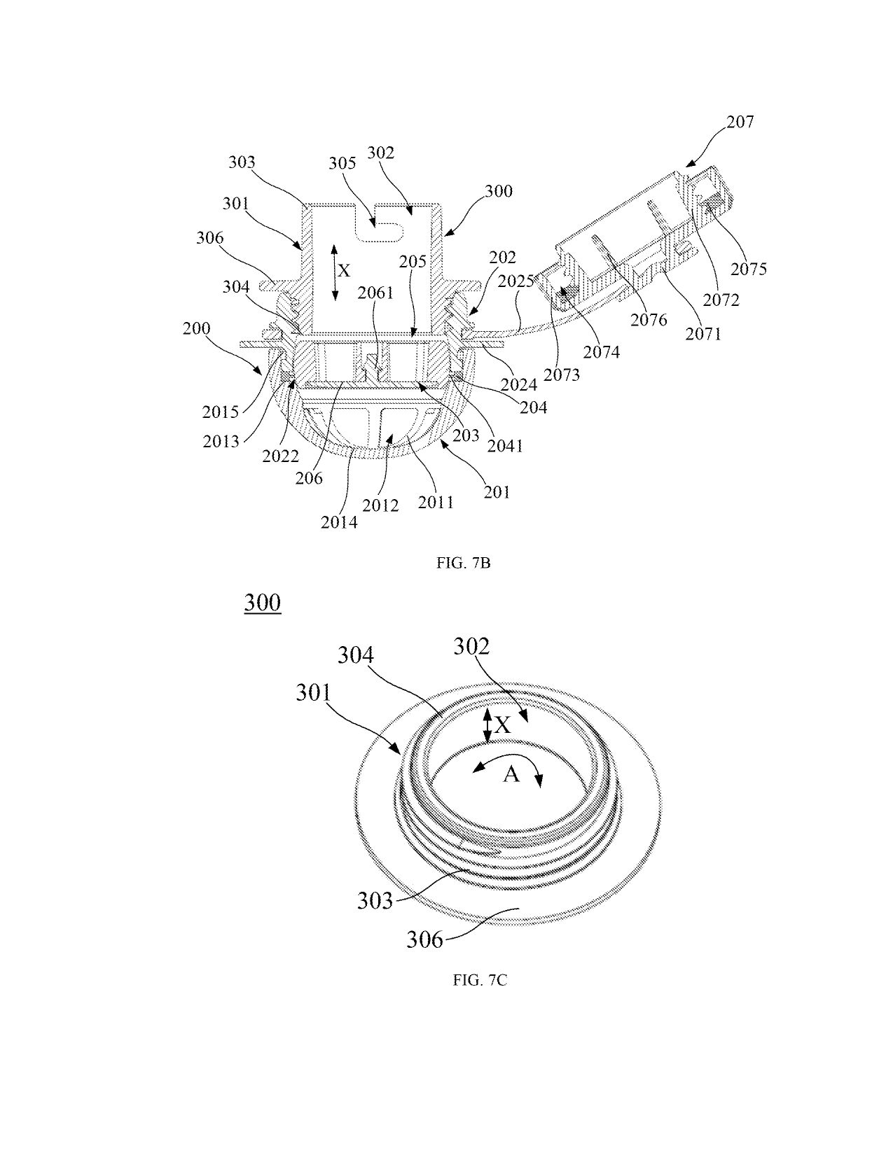

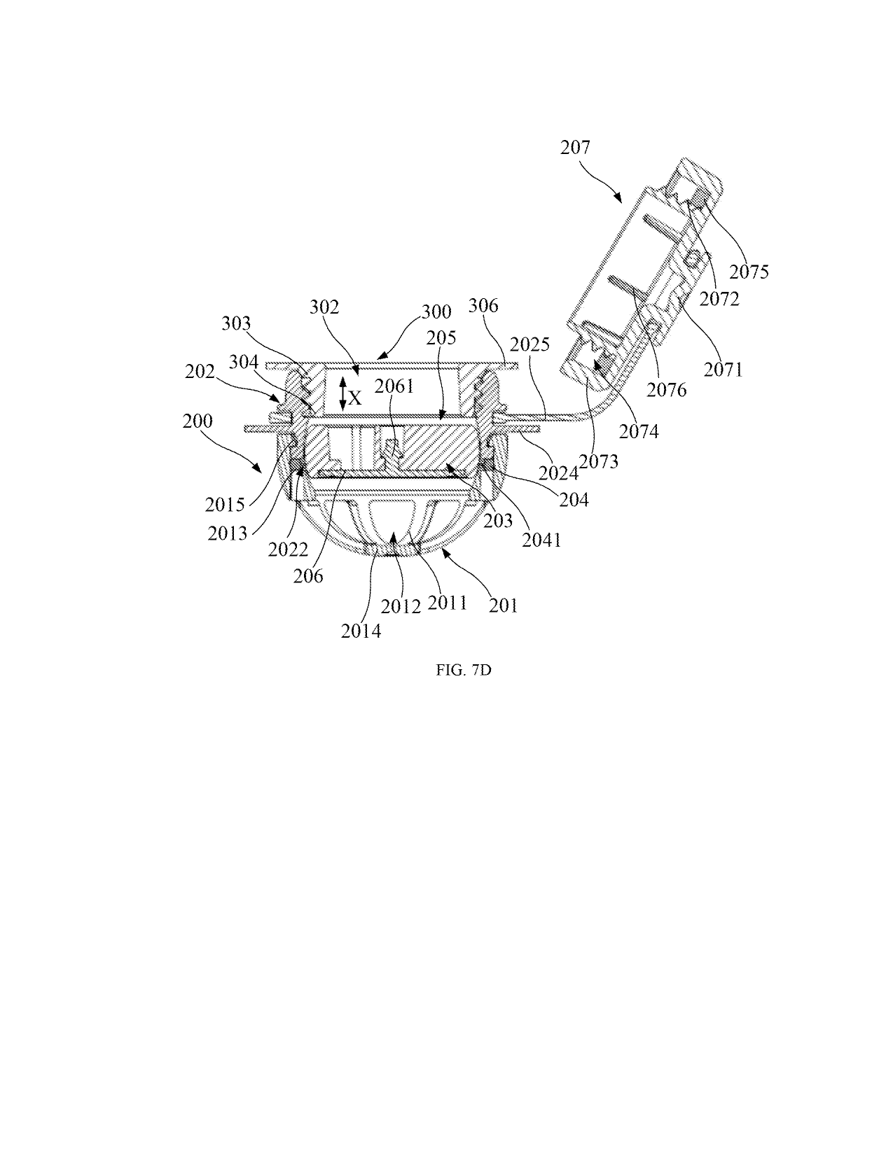

As illustrated more clearly in FIG. 4, the air valve may include the valve body 201, the valve seat 202, the valve core 203 and a first sealing member 204. The valve seat 202 may be connected to the valve body 201 to form a fluid channel 205, and the fluid channel 205 may be configured for communication with a second channel 302 of a connector 300, as will be described in additional detail herein with reference to FIG. 7A.

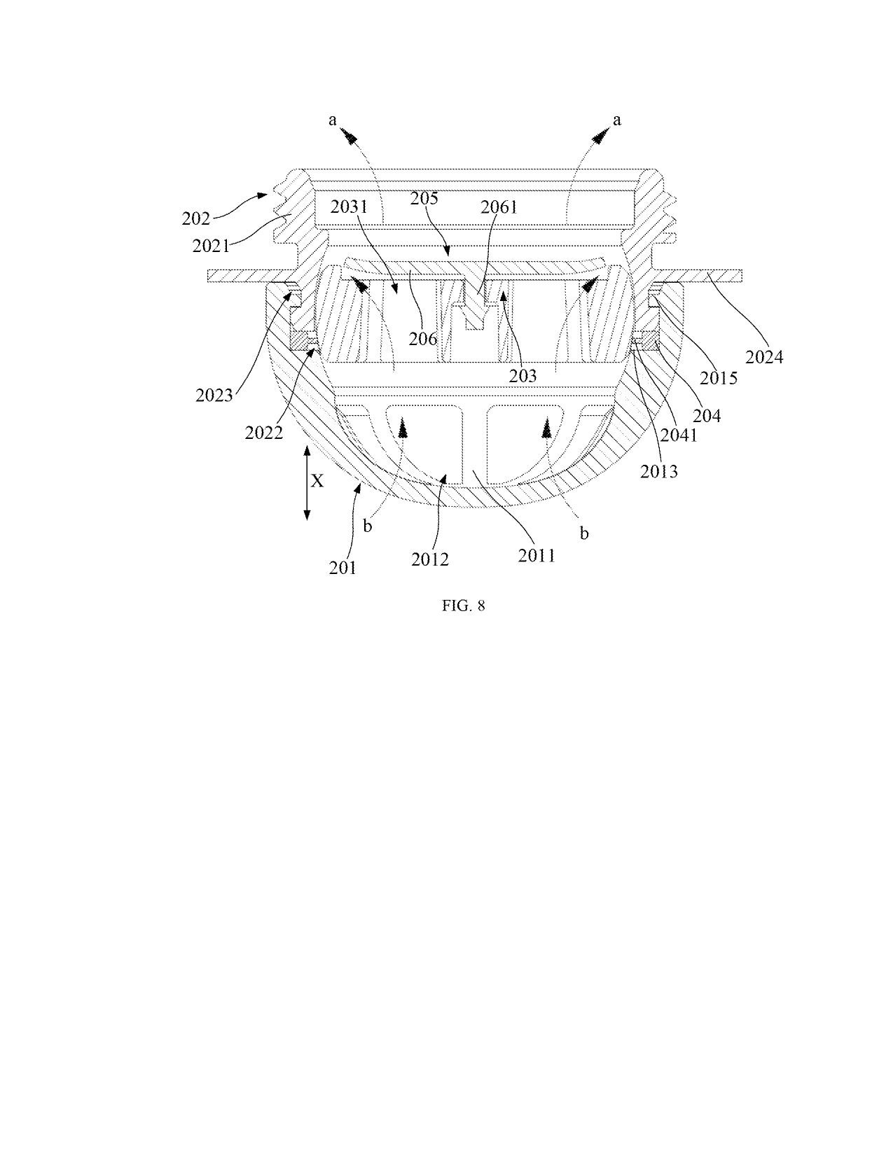

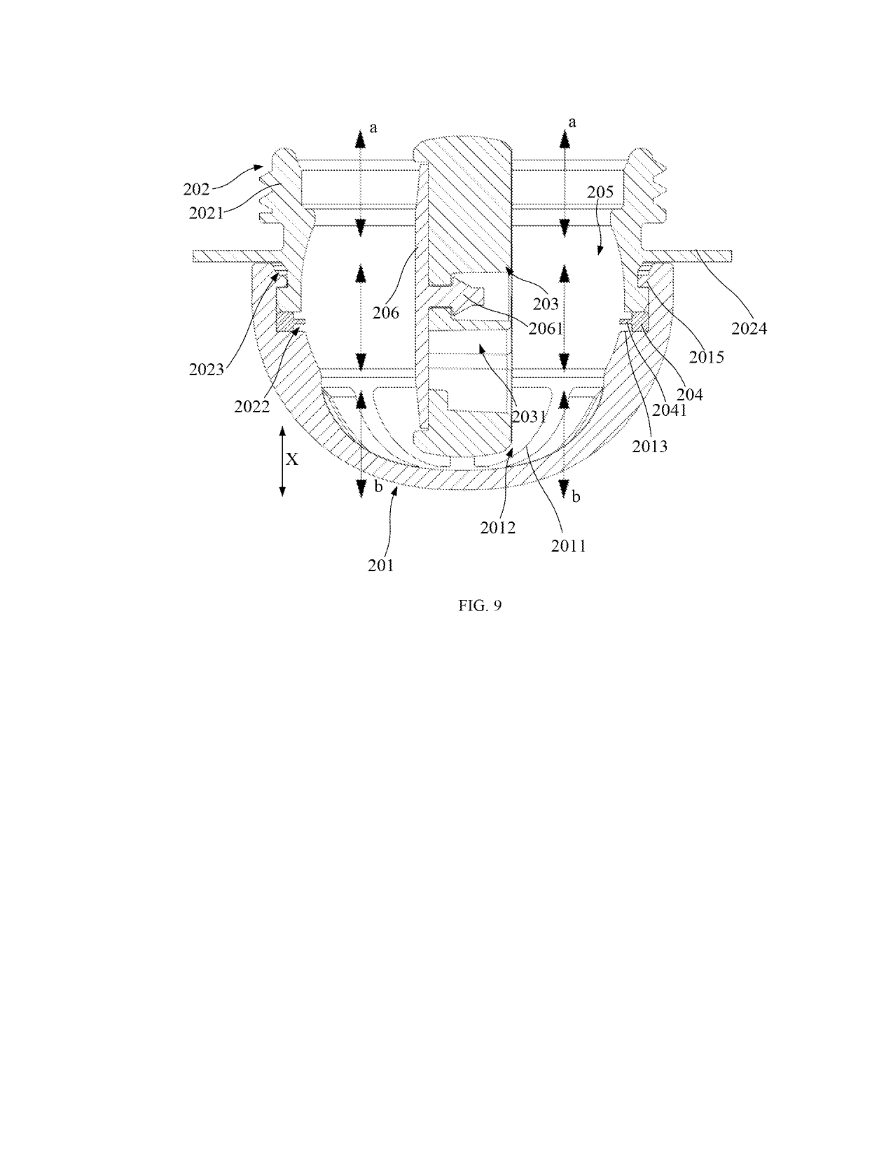

Referring still to FIGS. 3 and 4, the valve core 203 may include a plurality of air vents 2031. For example, as illustrated in FIGS. 3 and 4, the valve core 203 may include three air vents 2031. The valve core 203 may be located in the fluid channel 205, the air vents 2031 may be in communication with the fluid channel 205. Furthermore, the valve core 203 may be rotatably arranged in the fluid channel 205 relative to the valve seat 202, such that the valve core 203 can be switched between a first position (i.e., an inflation state shown in FIG. 7 and a deflation state shown in FIG. 8) and a second position (i.e., a rapid inflation/deflation state shown in FIG. 9). In these embodiments, the first sealing member 204 may surround the valve core 203 and may be limited between the valve body 201 and the valve seat 202. In some embodiments, the valve core 203 can rotate 360 degrees in the fluid channel 205 relative to the valve seat 202. For example, it should be understood that the valve core 203 may be capable of 360-degree omnidirectional rotation within the fluid channel 205, enabling unrestricted multi-axis movement centered at the position of the through hole 2035.

As further depicted in FIGS. 3 and 4, in the first position, the valve core 203 may be in contact with an inner wall 2051 of the fluid channel 205, and the first sealing member 204 may be in contact with the valve core 203 to seal the valve core 203 against the inner wall 2051 of the fluid channel 205. Furthermore, when the valve core is moved to the second position, the valve core 203 may be spaced apart from the inner wall 2051 of the fluid channel 205, such that the first sealing member 204 surrounds the valve core 203 and is spaced apart from the valve core 203.

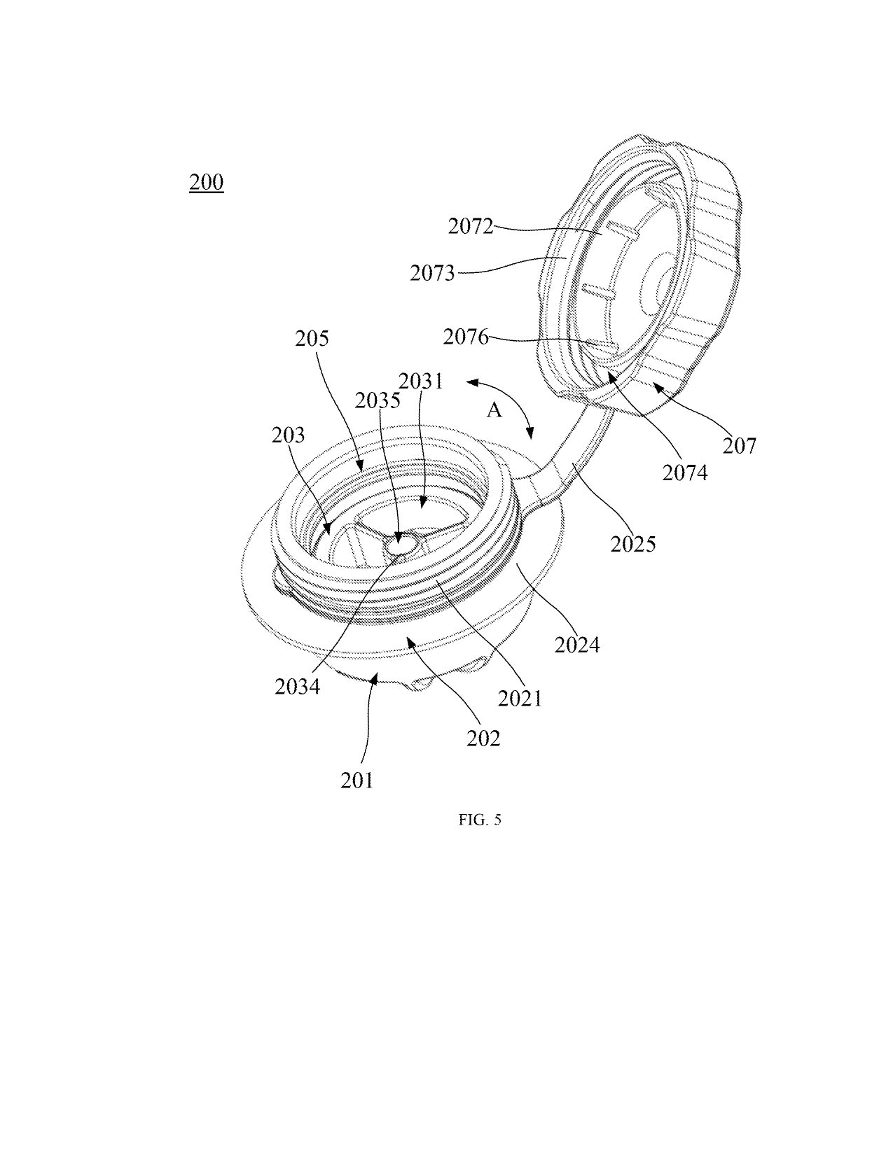

Turning now to FIG. 5, in some embodiments, the plurality of air vents (e.g., the three air vents) 2031 may be spaced apart in a circumferential direction (i.e., a direction A shown in FIG. 5), and the three air vents 2031 may be in communication with the fluid channel 205. However, the specific number and shape of the air vents 2031 are not limited to the embodiments of the present disclosure. For example, the air vents 2031 may include any number of air vents (e.g., three, four, five, etc.) and take any shape (e.g., fan shape, irregular shapes, etc.) without departing from the scope of the present disclosure.

Referring again to FIGS. 4 and 5, in some embodiments, the valve core 203 may further include a plurality of supports 2011. For example, as illustrated in FIGS. 4 and 5, the plurality of supports 2011 may include at least eight supports 2011, which may be provided on a side of the valve body 201 away from the valve seat 202. In these embodiments, the eight supports 2011 may be spaced apart from one another in the circumferential direction to form a plurality of air outlet through holes 2012. For example, the valve body 201 may be configured in a grid shape, and the air outlet through holes 2012 may be in communication with the fluid channel 205 to facilitate the flow of a fluid (e.g., air) through the valve body 201. In these embodiments, at least one end of each support 2011 may extend toward the valve seat 202 and may be connected to the first connecting portion 2013, the at least one other end (e.g., an opposite end) thereof may extend away from the valve seat 202 and may be connected by means of a second connecting portion 2014, with the second connecting portion 2014 being located at a bottom end of the valve body 201.

As described hereinabove, it should be appreciated that the eight supports 2011 forming air inlet/outlets (e.g., the air outlet through holes 2012) are provided at the bottom of the valve body 201, and the supports 2011 may be arc-shaped. However, the number and shape of each of the plurality of supports 2011 are not specifically limited in the embodiments of the present disclosure. For example, the plurality of supports 2011 may include three, five or ten supports and the supports may also be shaped as L-shaped, linear, or any other similar shape without departing from the scope of the present disclosure

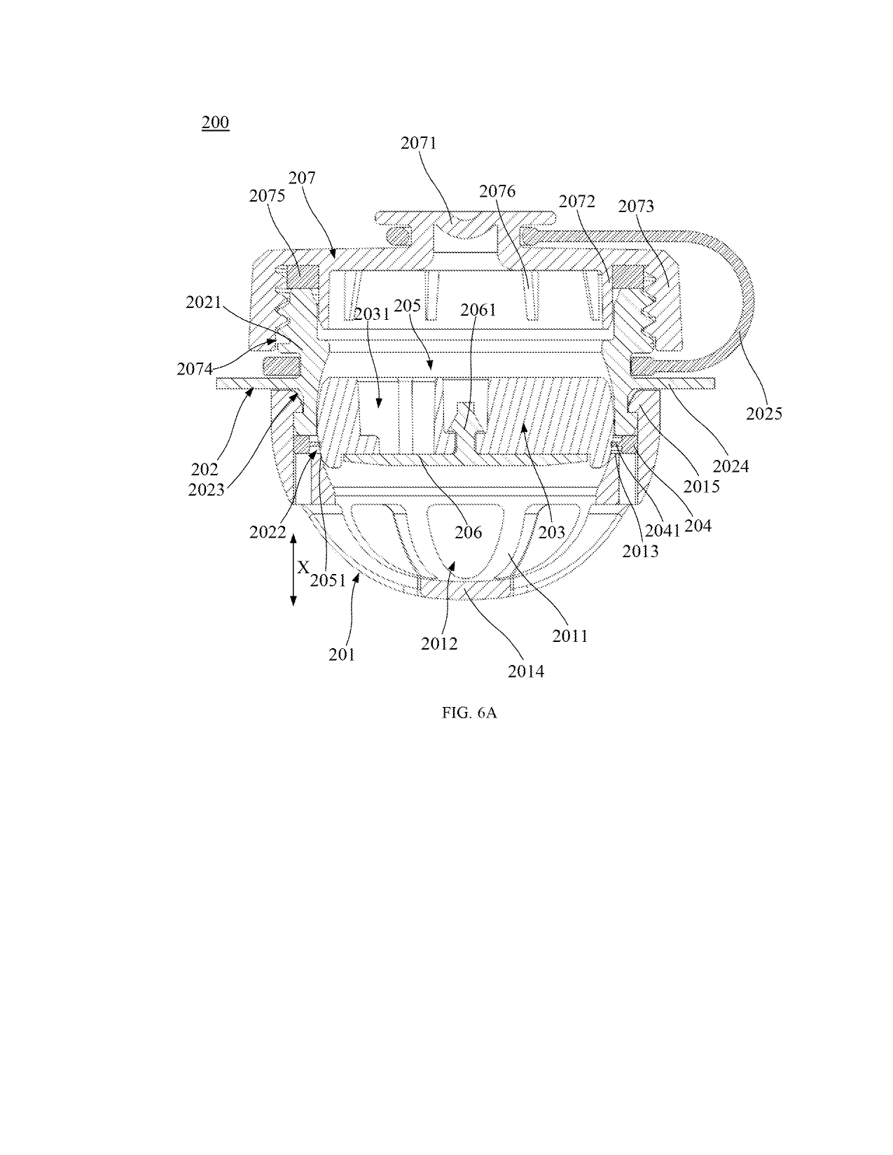

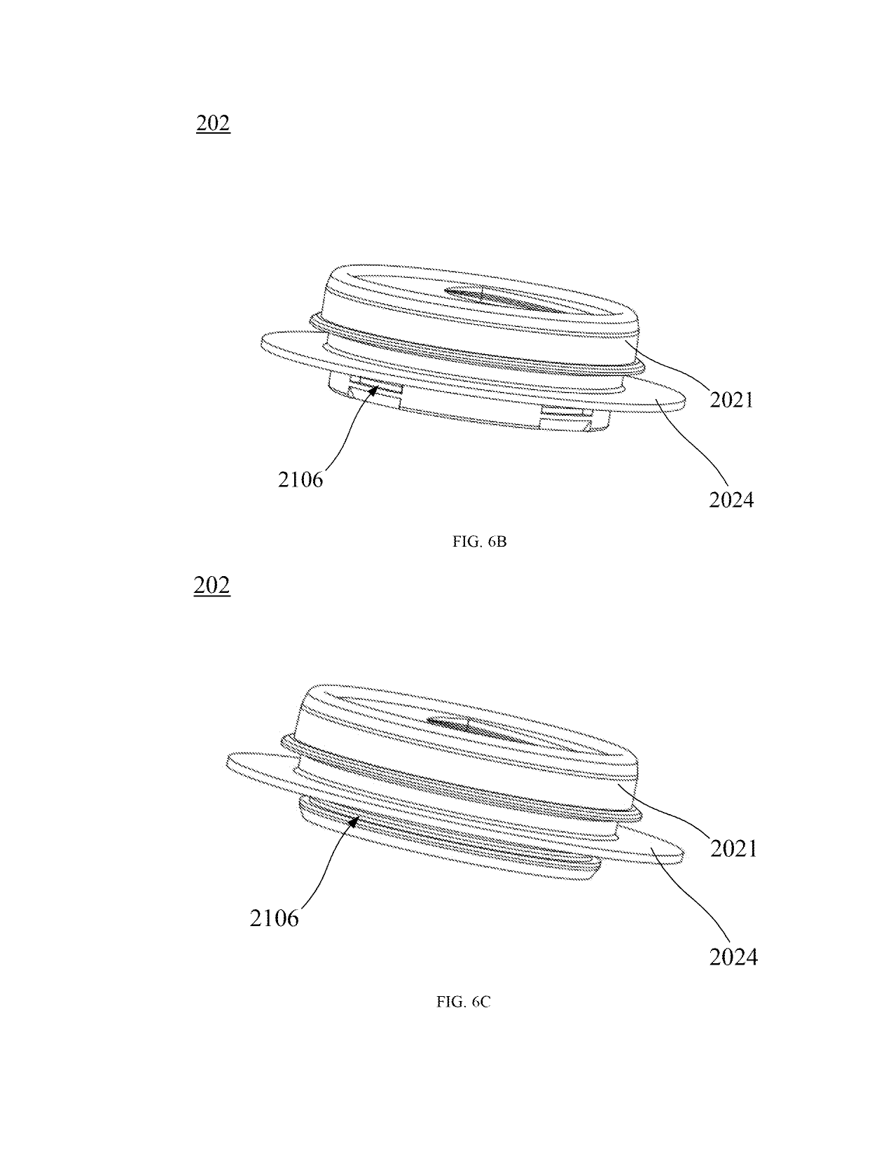

Turning now to FIGS. 5 and 6A, a valve cap of the air valve is depicted in additional detail. For example, in these embodiments, the first connecting portion 2013 may be arranged on an inner wall of the valve body 201 and may radially extend toward the fluid channel 205. Accordingly, it should be understood that the inner wall of the valve body 201 may protrude towards the fluid channel 205 to form the first connecting portion 2013.

In these embodiments, he valve seat 202 may also include a first main body portion 2021. The first main body portion 2021 may be internally hollow and may be connected to the valve body 201 to form the fluid channel 205, with the first main body portion 2021 extending in an axial direction (i.e., a direction X shown in FIG. 6A), such that the first main body portion 2021 and the first connecting portion 2013 are arranged opposite each other and spaced apart in the axial direction to form an accommodating space 2022. In these embodiments, the accommodating space 2022 may be further defined by the inner wall of the valve body 201, and the first sealing member 204 may be located in the accommodating space 2022.

Referring still to FIGS. 5-6C a hook 2015 may be provided at a top end of the inner wall of the valve body 201. In these embodiments, the hook 2015 and the first connecting portion 2013 may be spaced apart in the axial direction, a mounting portion 2023 may be provided on an outer wall of the first main body portion 2021, and the mounting portion 2023 may be configured for connection to the hook 2015 in a snap-fit manner to connect the valve seat 202 to the valve body 201 and clamp the first sealing member 204 in the accommodating space 2022.

It should be further appreciated that, in the embodiments described herein, the mounting portion 2023 may be a groove 2106 or a hole. In embodiments in which the mounting portion 2023 includes the groove 2106, the groove 2106 may further include a plurality of grooves spaced apart around the outer wall of the first main body portion 2021(e.g., as depicted in FIG. 6B), or a single, continuous groove 2106 (e.g., as depicted in FIG. 6C). It should be further understood that that the number of grooves 2106 or holes spaced apart around the outer wall of the first main body portion 2021 may correspond to the number of hooks 2015(e.g., four, six, eight, etc.), and it may be possible to provide any number of grooves (e.g., four, six, eight, etc.) or holes and hooks 2015 without departing from the scope of the present disclosure. Furthermore, although FIGS. 5-6B depict the number of grooves 2106 as corresponding to (e.g., being equal to ) the number of hooks 2015, in some embodiments, the number of grooves 2106 may be different from the number of hooks 2015 without departing from the scope of the present disclosure.

Referring still to FIGS. 5-6C an outer periphery of the valve core 203 may be in contact with the inner wall of the first main body portion 2021 of the valve seat 202 and the inner wall of the first connecting portion 2013 of the valve body 201, a plurality of ribs 2041 may be provided on a side of the first sealing member 204 facing the valve core 203, the plurality of ribs 2041 may be spaced apart in the circumferential direction, and the plurality of ribs 2041 all abut against the outer periphery of the valve core 203. In the first position (e.g., the inflation state shown in FIG. 7 and the deflation state shown in FIG. 8), the plurality of ribs 2041 may all abut against the valve core 203, and in the second position (e.g., the rapid inflation/deflation state shown in FIG. 9), the plurality of ribs 2041 may surround the valve core 203 and may be spaced apart from the valve core 203.

In these embodiments, the valve seat 202 and the valve body 201 may be connected together by means of a hook-fastening structure, a seal ring (e.g., the first sealing member 204 described above) of the air valve 200 may be arranged between the valve seat 202 and the valve body 201, and the seal ring may be firmly positioned by means of the connection between the valve seat 202 and the valve body 201 to prevent the seal ring (i.e., the first sealing member 204 described above) from loosening or becoming disengaged, thus reducing the risk of air leakage from the inflatable product. The outer periphery of the valve core 203 may be in contact with the inner wall of the valve seat 202 and the inner wall of the valve body 201, the plurality of ribs 2041 may be arranged at an edge of the seal ring (i.e., the first sealing member 204 described above), and the ribs 2041 may be in contact with the outer periphery of the valve core 203, thereby achieving a sealing effect.

It should be appreciated that, in the embodiments described herein, a length and a number of the ribs 2041 may be not limited, and at least one rib may be provided. For example, in some embodiments, one, two or three ribs may be provided and the rib may have a length of 1 mm, 2 mm, 3 mm, etc. The ribs 2041 may be shorter or thinner, so that a friction force between the seal ring and the valve core 203 can be reduced, thus facilitating the turning of the valve core 203.

As depicted most clearly in FIG. 5, it should be further understood that a part of an outer periphery of the first main body portion 2021 may protrude outwardly to form a first abutting portion 2024, and the first abutting portion 2024 may be configured to abut against the inflatable main body 100 described above. The first abutting portion 2024 may be annular, such that a projection of the first abutting portion extending in the axial direction may be annular. In these embodiments, a wall of the inflatable main body 100 may be connected to the first abutting portion 2024 of the air valve 200 by means of high-frequency welding or hot melting to arrange the air valve 200 on the wall of the inflatable main body 100.

Turning now to FIGS. 4-6C a connecting strap 2025 may also be connected to the first main body portion 2021, the connecting strap 2025 may be spaced apart from the first abutting portion 2024 in the axial direction, the connecting strap 2025 may be located above the first abutting portion 2024 (that may be, the first abutting portion 2024 may be closer to the valve body 201) in the axial direction, and a snap-fit through hole 2026 may be provided in an end of the connecting strap 2025 away from the first main body portion 2021.

In the embodiments described herein, the air valve 200 may further include a valve diaphragm 206. The valve diaphragm 206 may be located on a side of the valve core 203 facing the valve body 201, and the valve diaphragm 206 may be connected to the valve core 203 by means of a connecting rod 2061 and covers the three air vents 2031 described above.

Referring now to FIGS. 7 - 8, the valve core of the air valve is depicted in a first position in which the valve core is rotatable between an inflation state and a deflation state, respectively. For example, when a user presses the valve core 203 in the inflation state in the first position shown in FIG. 7, the valve core 203 in an airflow channel (e.g., the fluid channel 205) defined by the valve seat 202 may be flipped to the deflation state in the first position. When the user presses and rolls up the inflatable mattress or the TPU inflatable sponge mattress for deflation, due to the one-way valve diaphragm 206 arranged on the valve core 203, it may be possible to prevent outside air from flowing back into the inflatable mattress or the TPU inflatable sponge mattress.

Turning now to FIG. 9, the valve core of the air valve may be moved to a second position to allow for rapid deflation or inflation. For example, after the inflatable mattress or the TPU inflatable sponge mattress is used, the valve core may be flipped to be in the second position shown in FIG. 9, allowing the air inside the mattress to be discharged quickly.

In these embodiments, when the user unfolds the rolled-up TPU inflatable sponge mattress for reuse, the valve core 203 may be flipped to be in the second position shown in FIG. 9, and the TPU inflatable sponge mattress may quickly draw in the outside air due to the expansion effect of the sponge itself, allowing the mattress to unfold naturally. Subsequently, when an air pump is needed to replenish the inflatable main body with the air, the valve core 203 may be flipped to the inflation state in the first position shown in FIG. 7.

Accordingly, in the inflation state (e.g., when the inflatable main body 100 described above needs to be inflated), the valve core 203 may be rotated in the fluid channel 205 until the valve diaphragm 206 is located at the bottom end of the valve core 203 in the axial direction (i.e., in the direction X shown in FIG. 7). In these embodiments, the valve diaphragm 206 may then be closer to the air outlet through holes 2012 of the valve body 201. In other words, the valve diaphragm 206 may only allow fluid to enter the inflatable main body 100. When the inflatable main body 100 is inflated by using the air pump, under the pressure of an airflow from the air pump, the fluid then flows along arrows shown in FIG. 7 (e.g., from end “a” to end “b”), the fluid pushes at least a part of the valve diaphragm 206 in a direction close to the inflatable main body 100, so as to separate the valve diaphragm 206 from the air vents 2031. That is, the air vents 2031 are then partially in a conducting state, and the entire fluid channel 205 may be in an open state, such that the fluid can enter the air outlet through holes 2012 through the air vents 2031 to inflate the inflatable main body 100.

In the process of inflating the inflatable main body 100, the air valve 200 may also be connected to an external inflation apparatus by using the connector 300.

Referring now to FIGS. 7 to 7D and in, the fluid channel 205 may be configured for communication with the second channel 302 of the connector 300 described above. For example, the valve seat 202 of the air valve 200 may be connected to the inflatable main body 100 such that the valve body 201 of the air valve 200 may be located in the inflatable chamber. One end of the connector 300 may be connected to the air valve 200, and the other end thereof may be connected to an air nozzle of the external apparatus (e.g., the air pump) to inflate or deflate the inflatable mattress or the TPU inflatable sponge mattress (an air pump having an air extraction function being used to connect to the connector for deflation). The wall of the inflatable main body 100 may be connected to the valve seat 202 of the air valve 200 by means of high-frequency welding or hot melting to arrange the air valve 200 on the wall of the inflatable main body 100.

Referring now to FIGS. 7-7D, the air valve 200 may be used in cooperation with a connector 300. In these embodiments, the connector 300 may be connected to the air nozzle of the air pump (i.e., the external apparatus) to inflate or deflate the inflatable mattress or the TPU inflatable sponge mattress (the air pump having an air extraction function being used to connect to the connector for deflation).

For example, as illustrated in FIGS. 7A and 7B, the connector 300 may include a connector body 301. The connector body 301 extends in the axial direction (i.e., the direction X shown in FIG. 7A), and the connector body 301 may be internally hollow to form the second channel 302. In these embodiments the connector body 301 may include a first end 303 and a second end 304 that may be arranged opposite each other in the axial direction, the first end 303 may be provided with a recess 305, the recess 305 abuts against the external apparatus (e.g., the air pump), and the second end 304 may be provided with a thread and may be threadedly connected to the air valve 200, such that the air pump may be connected to the air valve 200 to inflate or deflate the inflatable mattress or the TPU inflatable sponge mattress. In some embodiments, an outer wall of the second end 304 may be provided with an external thread, an inner wall of the valve seat 202 may be provided with an internal thread, and the second end 304 may be threadedly connected to the valve seat 202 by the internal thread mating with the external thread. It should be further appreciated that, in these embodiments, the second end 304 may be provided with an internal thread and the outer wall of valve seat 202 may be provided with an external thread to threadedly connect the second end 304 to the valve seat 202.

It should be noted that the shape and number of the recesses 305 are not limited in the embodiments of the present disclosure, and the specific shape thereof may be selected according to the shape of the air pump. For example, in some embodiments, the recesses 305 may include an L-shape, and the number thereof may also be selected according to the shape of the air pump. In these embodiments, the recesses 305 may include any number of recesses without departing from the scope of the present disclosure.

In the embodiments described herein, a protruding portion 306 may be provided on a side wall of the connector body 301 close to the second end 304, and the protruding portion 306 surrounds the side wall of the connector body 301 and may be located at the top of the valve seat 202 of the air valve 200 described later. The shape of the protruding portion 306 may be not limited in the embodiments of the present disclosure, and the protruding portion may have a circular shape, or a quadrangular shape or other irregular shapes such as a plum-petal shape, or any other similar shape without departing from the scope of the present disclosure.

Referring again to FIGS. 7-7D, a plurality of weight reduction recesses 307 may also be provided on an outer periphery of the protruding portion 306 to achieve a weight reduction function. Moreover, a protrusion formed between adjacent weight reduction recesses 307 can facilitate the user to rotate the connector 300 for mounting on the valve seat 202. The plurality of weight reduction recesses 307 may be spaced apart in a circumferential direction (i.e., a direction A shown in FIG. 7A). The shape and number of the weight reduction recesses 307 may be not specifically limited in the embodiments of the present disclosure. For example, it may be possible to provide two arc-shaped weight reduction recesses 307, three circular weight reduction recesses 307, or four square weight reduction recesses 307, etc.

In other embodiments, such as those depicted in FIGS. 7C and 7D, the connector 300 may include a connector body 301 and a protruding portion 306. The connector body 301 may extend in the axial direction (e.g., the direction X shown in FIG. 7C), and the connector body 301 may be internally hollow to form a second channel 302; and the connector body 301 includes a first end 303 and a second end 304 that may be arranged opposite each other in the axial direction, the first end 303 may be configured for connection to the external apparatus (e.g., the air pump) to insert the external apparatus into the second channel 302, the second end 304 may be provided with a thread and may be threadedly connected to the air valve 200, such that the air pump may be connected to the air valve 200 to inflate or deflate the inflatable mattress or the TPU inflatable sponge mattress.

In these embodiments, an outer wall of the second end 304 may be provided with an external thread, an inner wall of the valve seat 202 may be provided with an internal thread, and the second end 304 may be threadedly connected to the valve seat 202 by the internal thread mating with the external thread. It should be further appreciated that the second end 304 may be provided with an internal thread and the outer wall of valve seat 202 may be provided with an external thread to threadedly connect the second end 304 to the valve seat 202. The protruding portion 306 surrounds an outer periphery of the first end 303, and the protruding portion 306 may be arranged at the top of the valve seat 202 of the air valve 200 described later. The shape of the protruding portion 306 may not be limited in the embodiments of the present disclosure, and the protruding portion may have a circular shape, a quadrangular shape any other regular or irregular shape, without departing from the scope of the present disclosure.

Accordingly, it should be appreciated that, during inflation, the air pump inflates the air valve 200 by means of the connector 300, and the air enters the fluid channel 205 from the second channel 302 and then flows through the air outlet through holes 2012 and into the inflatable chamber of the inflatable main body 100.

During inflation, if the airflow in the inflatable main body 100 flows back outwardly, that may be, flows in a direction opposite the arrows shown in FIG. 7 (e.g., from end “b” to end “a”), and the back flowing air pushes the valve diaphragm 206 in a direction away from the inflatable main body 100, namely, toward the air vents 2031. In this way, the valve diaphragm 206 closes the air vents 2031, thereby preventing the air from flowing back.

Referring to FIG. 8 and in conjunction with FIG. 1, in the deflation state, the valve core 203 may be rotated in the fluid channel 205 until the valve diaphragm 206 is located at the top end of the valve core 203 in the axial direction (i.e., the direction X shown in FIG. 8), that is, the valve diaphragm 206 may be far away from the air outlet through hole 2012 of the valve body 201. In other words, the valve diaphragm 206 may only allow the fluid to flow out of the inflatable main body 100. In this case, when the inflatable main body 100 is pressed, since the pressure of the air in the inflatable main body 100 may be greater than the external atmospheric pressure, the fluid flows along arrows shown in FIG. 8 (e.g., from end “b” to end “a”), the fluid pushes at least a part of the valve diaphragm 206 in a direction away from the inflatable main body 100. Accordingly, the air vents 2031 may be partially in the conducting state, so as to separate the valve diaphragm 206 from the air vents 2031, and the entire fluid channel 205 may be in the open state, such that the fluid can flow out of the interior of the inflatable main body 100 to deflate the inflatable main body 100.

Similarly, during deflation, if the air in the external environment flows back into the inflatable main body 100 in a direction opposite the arrows shown in FIG. 8 (e.g.,, from end “a” to end “b”), the back flowing air pushes the valve diaphragm 206 in the direction close to the inflatable main body 100, namely, toward the air vents 2031. In this way, the valve diaphragm 206 closes the air vents 2031, thereby preventing the air from flowing back.

When needing to rapidly deflate the inflatable main body 100, the user rotates the valve core 203 to the state shown in FIG. 9, such that the valve core 203 is in a vertical state relative to the fluid channel 205. In this way, the blocking of the fluid channel 205 by the valve core 203 may be minimized, facilitating the rapid outflow of the air in the inflatable main body 100. When needing to rapidly inflate the inflatable main body 100, the user may also rotate the valve core 203 to the state shown in FIG. 9, such that the valve core 203 is in the vertical state relative to the fluid channel 205, and the TPU inflatable sponge mattress can quickly draw in the outside air due to the expansion effect of the sponge itself, allowing the mattress to unfold naturally. Subsequently, when the air pump is needed to replenish the inflatable main body with the air, the valve core 203 may be flipped to the inflation state shown in FIG. 7. During switching of the valve core 203 from the first position shown in FIGS. 7-8 to the second position shown in FIG. 9, the user may rotate the valve core 203 to change the size of an opening of the fluid channel, thus adjusting an inflation/deflation speed of the inflatable main body 100.

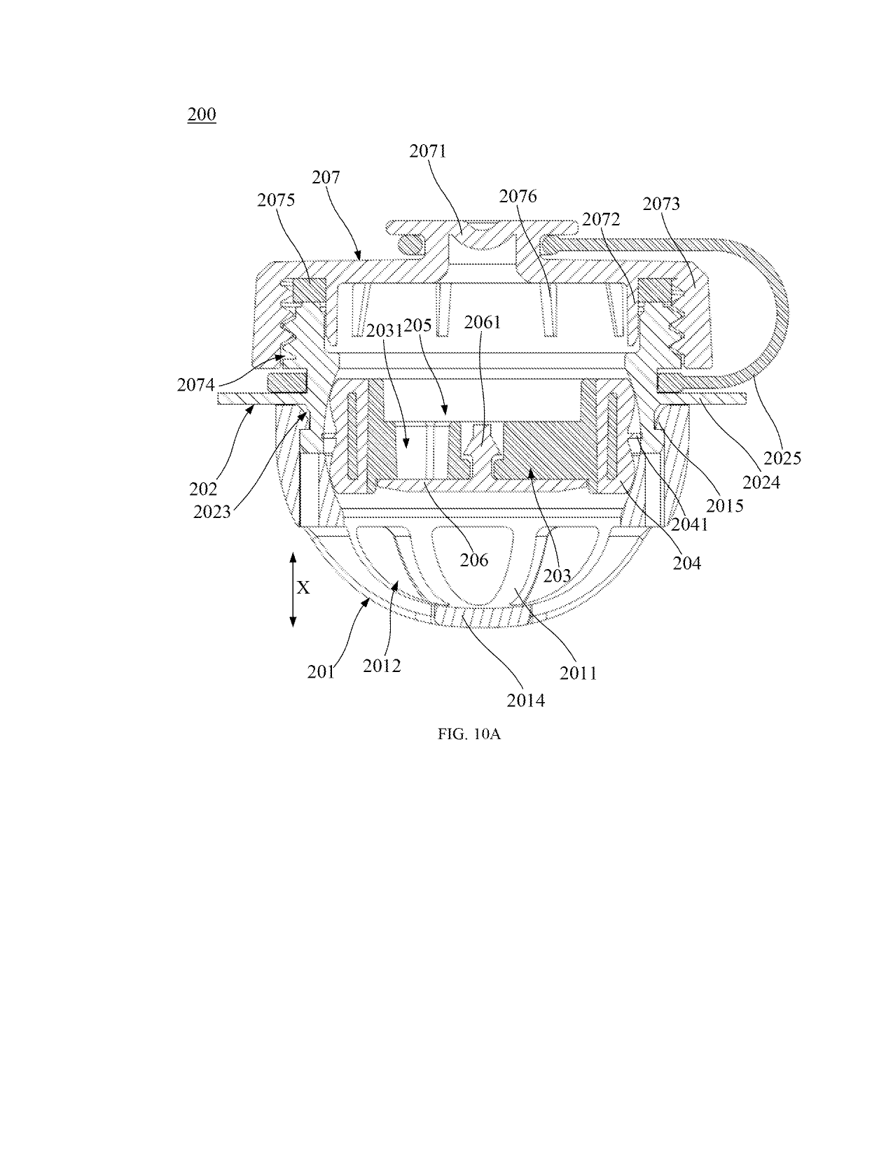

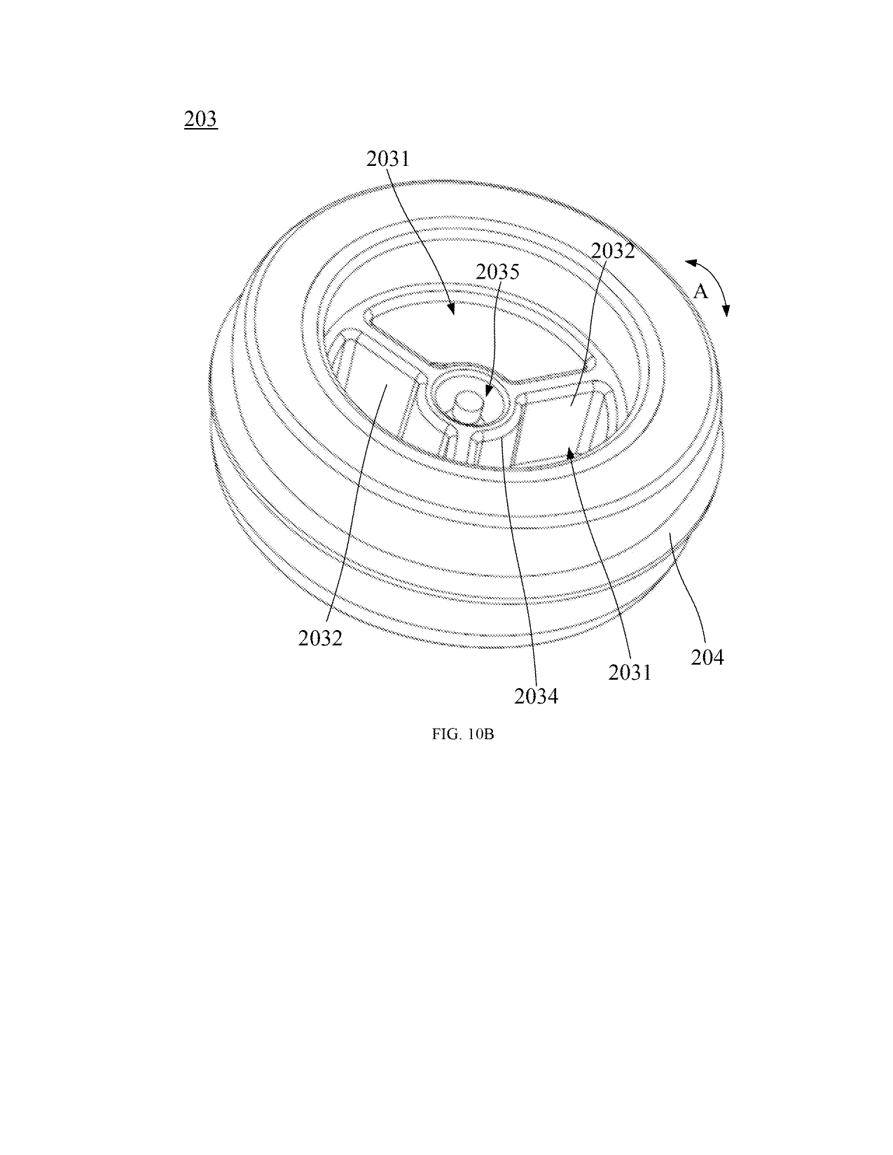

Referring now to FIGS. 10A and 10B, the air valve 200 may further include a valve cap 207, which may be connected to the valve seat by a thread on the valve cap mating with an external thread provided at an end of the valve seat.

In other possible implementations, the seal ring (e.g., the first sealing member 204 described above) of the air valve may be arranged on the valve core 203 along a circumferential edge of the valve core 203 by using a rubber-coated structure, the seal ring may be in contact with the inner wall of the valve seat 202 and the inner wall of the valve body 201, and the ribs 2041 on an outer wall of the seal ring may be also in contact with the inner wall of the valve seat 202, so that a better sealing effect can be achieved.

Referring now to FIGS. 10A-11, the valve cap 207 may further include a snap-fit portion 2071 that may be provided at the top of the valve cap 207, and the snap-fit through hole 2026 (shown in FIG. 4) of the connecting strap 2025 may engage with the snap-fit portion 2071 to connect the valve cap 207 to the valve seat 202, thereby preventing the valve cap 207 from being lost. The valve cap 207 includes a first portion 2072 and a second portion 2073. The first portion 2072 and the second portion 2073 may be spaced apart in the radial direction to form a connecting groove 2074, and the connecting groove 2074 may be configured to accommodate the valve seat 202 and may be threadedly connected to the valve seat. A second sealing member 2075 may be provided in the connecting groove 2074 to enable a sealed connection between the valve cap 207 and the valve seat 202.

In these embodiments, the valve cap 207 and the valve seat 202 may be connected as shown in FIG. 10A. For example, an outer wall of the connecting groove 2074, that is, a wall of the second portion 2073 facing the fluid channel 205 in the radial direction may be provided with an internal thread, an outer wall of a top end of the valve seat 202 may be provided with an external thread, and the internal thread and the external thread may be threadedly connected to each other to connect the valve cap 207 to the valve seat 202. In other embodiments, such as the embodiment depicted in FIG. 11, the valve cap 207 and the valve seat 202 may be connected such that an inner wall of the connecting groove 2074, that is, a wall of the first portion 2072 facing away from the fluid channel 205 in the radial direction may be provided with an external thread, an inner wall of the top end of the valve seat 202 may be provided with an internal thread, and the internal thread and the external thread may be threadedly connected to each other to connect the valve cap 207 to the valve seat 202.

Turning now to FIG. 5, in some embodiments, the first portion 2072 may be internally hollow and may be in communication with the fluid channel 205, an inner wall of the first portion 2072 facing the fluid channel 205 in the radial direction may be provided with a plurality of reinforcing ribs 2076, and the plurality of reinforcing ribs 2076 may be spaced apart in the circumferential direction (i.e., the direction A shown in FIG. 5), so as to enhance the stiffness of the valve cap 207 and improve the sealing effect of the air valve 200 after the valve cap 207 is connected to the valve seat 202.

It should be appreciated that the number and shape of the reinforcing ribs 2076 may not be limited in the embodiments of the present disclosure. For example, the reinforcing ribs may include five, eight, ten, or any other number of ribs and the ribs may be in an elongated shape, a circular shape, or any other regular or irregular shape without departing from the scope of the present disclosure.

Referring again to FIGS. 10A-11, the air valve 200 may further include a valve body 201, a valve seat 202, a valve core 203 and a first sealing member 204. The first sealing member 204 of the air valve 200 may also be configured as shown in FIG. 10A or FIG. 9. The valve seat 202 may be connected to the valve body 201 to form a fluid channel 205, and the fluid channel 205 may be configured for communication with the second channel 302 of the connector 300 described above (see FIG. 7B or FIG. 7D). The valve core 203 may include three air vents 2031. The valve core 203 may be located in the fluid channel 205, the air vents 2031 may be in communication with the fluid channel 205, and the valve core 203 may be rotatably arranged in the fluid channel 205 relative to the valve seat 202, such that the valve core 203 can be switched between a first position (e.g., the inflation state shown in FIG. 7 and the deflation state shown in FIG. 8) and a second position (e.g., the rapid inflation/deflation state shown in FIG. 9), and in conjunction with FIG. 10B, the first sealing member 204 surrounds the valve core 203 and may be integrally formed with the valve core 203.

In the first position (e.g., the inflation state shown in FIG. 7 and the deflation state shown in FIG. 8), the valve core 203 may be in contact with an inner wall 2051 of the fluid channel 205, and the first sealing member 204 may be in contact with the inner wall 2051 of the fluid channel 205 and seals the valve core 203 against the inner wall 2051 of the fluid channel 205 In the second position (e.g., the rapid inflation/deflation state shown in FIG. 9), the valve core 203 may be spaced apart from the inner wall 2051 of the fluid channel 205, and the first sealing member 204 may be spaced apart from the inner wall 2051 of the fluid channel 205.

As an example, the first sealing member 204 may be arranged on the valve core 203 along the circumferential edge of the valve core 203 by using a rubber-coated structure, the first sealing member 204 may be in contact with the inner wall of the valve seat 202 and the inner wall of the valve body 201, and the ribs 2041 on the outer wall of the first sealing member 204 may be also in contact with the inner wall of the valve seat 202, so that a better sealing effect can be achieved.

Accordingly, in these embodiments, the first sealing member 204 may surround the valve core 203 and may be integrally formed with the valve core 203 to enable a sealed connection between the valve core 203 and the valve seat 202 and the valve body 201. A plurality of ribs 2041 may be provided on a side of the first sealing member 204 facing the inner wall of the fluid channel 205, the plurality of ribs 2041 may be spaced apart in the circumferential direction, and the plurality of ribs 2041 all abut against the valve seat 202. In the first position, the plurality of ribs 2041 all abut against the inner wall 2051 of the fluid channel 205; and in the second position, the plurality of ribs 2041 may be spaced apart from the inner wall 2051 of the fluid channel 205.

Similarly, the length and the number of the ribs 2041 may not be limited in the embodiments of the present disclosure. For example, the number of ribs 2041 may include one, two, three, four, five, or any other number of ribs and the ribs may have a length of 1 mm, 2 mm, 3 mm, or any other similar length without departing from the scope of the present disclosure. In these embodiments, the ribs 2041 may be shorter or thinner, so that the friction force between the first sealing member 204 and the valve core 203 can be reduced, thus facilitating the turning of the valve core 203. Those skilled in the art should understand that the connector shown in FIGS. 7A and 7C may also be used for the above air valve as shown in FIGS. 10A and 11.

It should be further appreciated that the valve cap 207 may be connected to the valve seat by means of an internal or external thread provided at an end of the valve seat 202. In these embodiments, the thread of the valve cap 207 and/or the valve seat 202 has no bearing on the replacement of structures of the valve cores 203 described hereinabove.

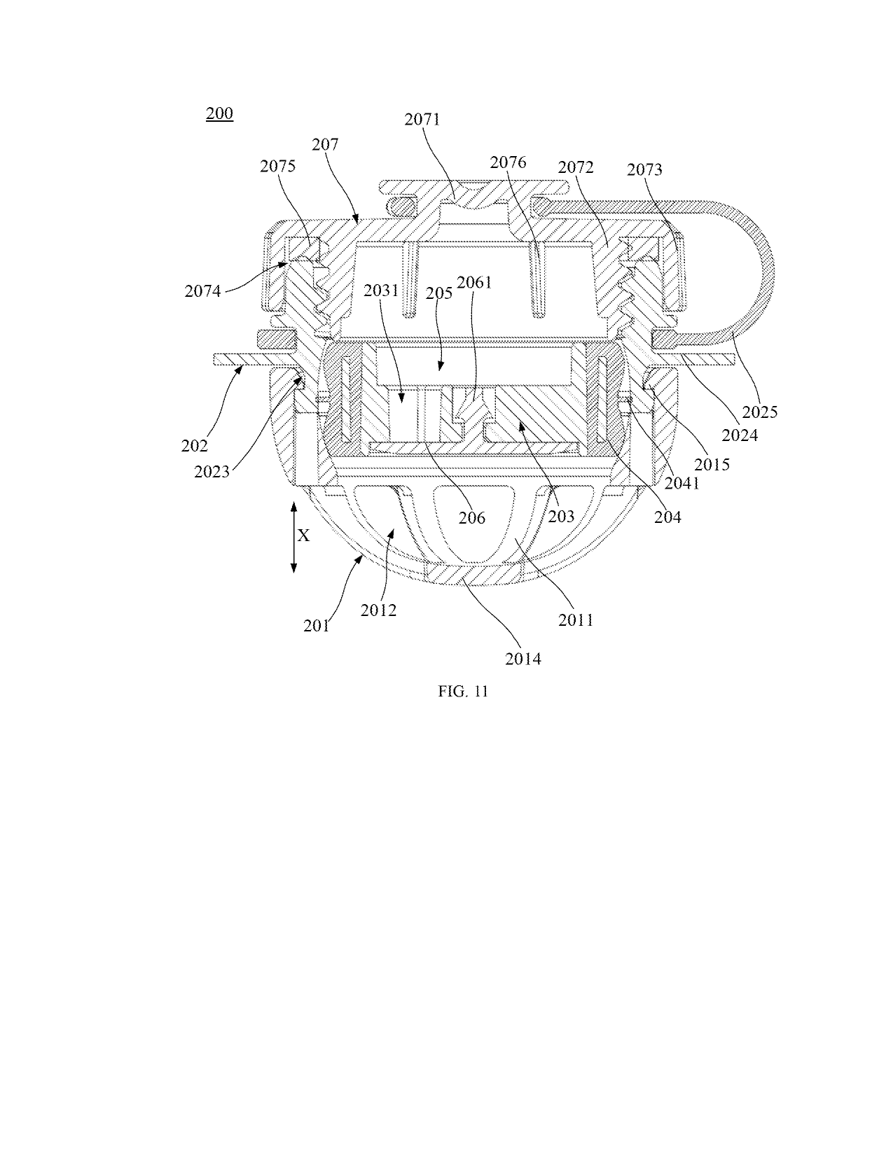

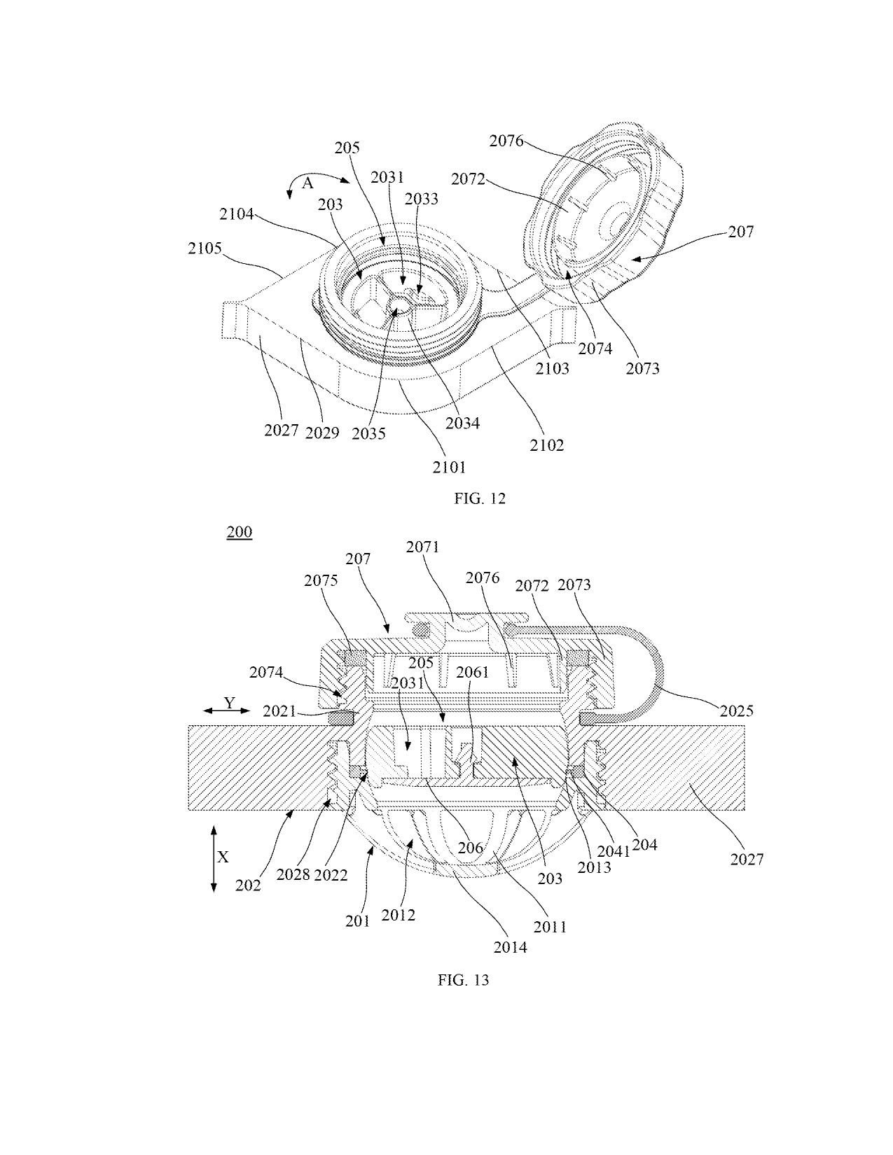

Turning now to FIG. 12, a schematic perspective structural view of another embodiment of an air valve is depicted. For example, as depicted most clearly in FIGS. 12 and 13, an outer periphery of the first main body portion 2021 may protrude outwardly to form a second abutting portion 2027, the second abutting portion 2027 may axially extend in a direction close to the valve body 201 and may be spaced apart from the first main body portion 2021 in a radial direction (i.e., a direction Y shown in FIG. 13) to form an annular groove 2028, and the annular groove 2028 may be configured to accommodate the valve body 201 and may be in threaded fit with an outer wall of the valve body 201 to clamp the first sealing member 204 in the accommodating space 2022.

In these embodiments, the air valve may further include a projection of the second abutting portion 2027 that extends in the axial direction and includes a first straight segment 2029, a first circular arc segment 2101, a second straight segment 2102, a third straight segment 2103, a second circular arc segment 2104 and a fourth straight segment 2105 that may be connected to each other. The second abutting portion 2027 may be of a shuttle-like structure.

Referring now to FIGS. 13-16, the valve cap is depicted being connected to a valve seat via a thread on the valve cap mating with an external thread provided at an end of the valve seat. In these embodiments, the seal ring (e.g., the first sealing member 204 described above) of the air valve may be arranged on the valve core 203 along the circumferential edge of the valve core 203 by using a rubber-coated structure, the seal ring (e.g., the first sealing member 204 described above) may be in contact with the inner wall of the valve seat 202 and the inner wall of the valve body 201, and the ribs 2041 on the outer wall of the seal ring (e.g. the first sealing member 204 described above) may be also in contact with the inner wall of the valve seat 202, so that a better sealing effect can be achieved.

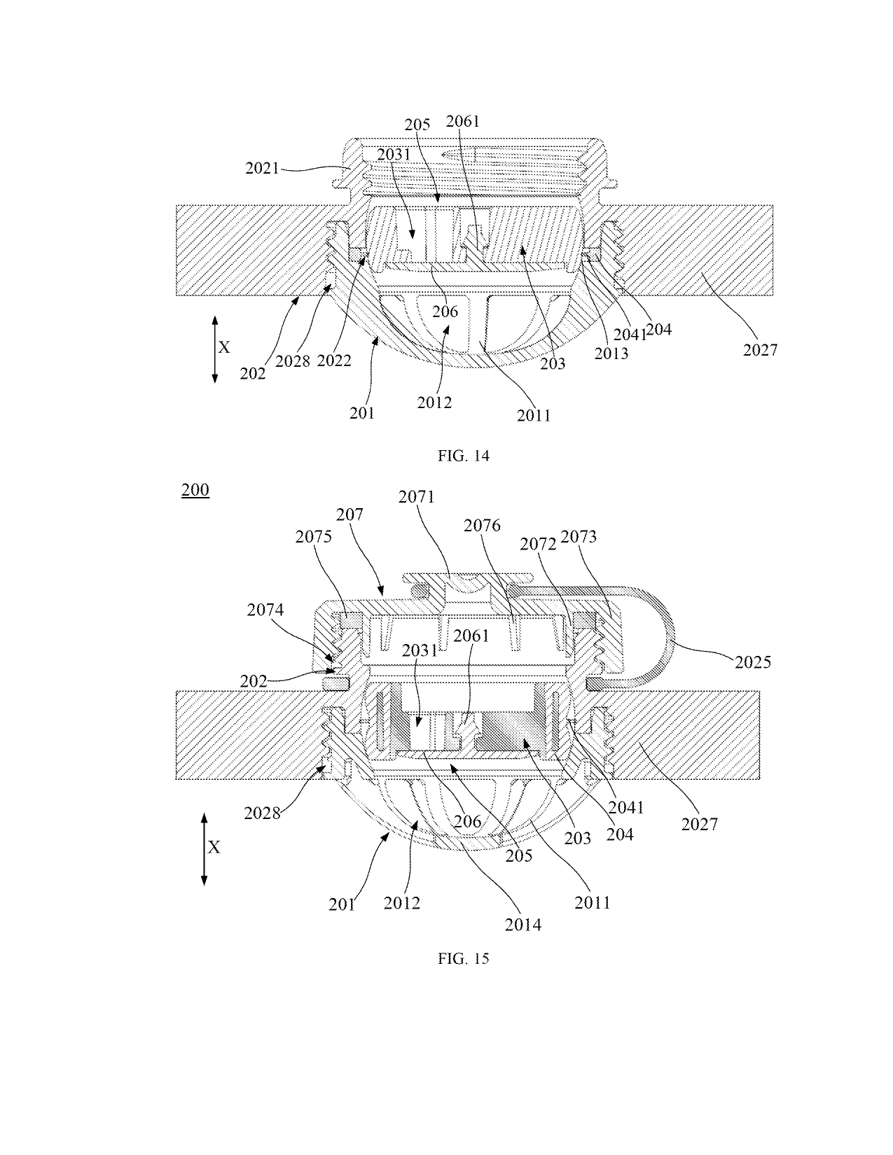

In some embodiments, such as the embodiment depicted in FIG. 14, the seal ring (e.g., the first sealing member 204 described above) may be clamped between the valve seat 202 and the valve body 201 by means of the threaded connection between the valve seat 202 and the valve body 201, thus preventing the seal ring (i.e., the first sealing member 204 described above) from becoming loose and/or detached, which would negatively impact the sealing effect of the seal ring. In these embodiments, the seal ring may further include a plurality of ribs 2041 arranged at the edge of the seal ring (e.g., the first sealing member 204 described above), and the ribs 2041 may be in contact with a wall of the valve core 203, thereby achieving the sealing effect.

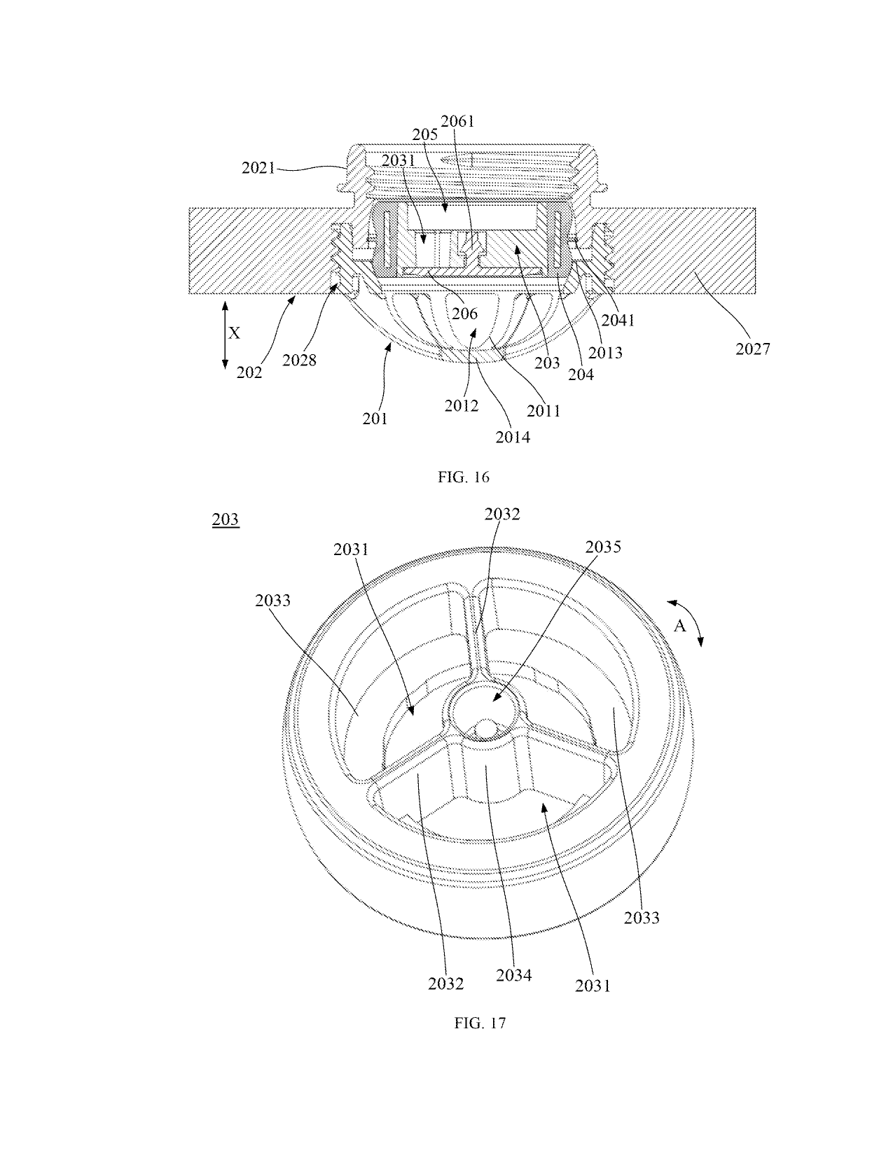

Turning now to FIG. 17, another embodiment of the valve core 203 is depicted in additional detail. In these embodiments, the valve core 203 may be provided with the air vents 2031 described above, and the air vents 2031 may be divided into three equal parts in a fan shape. The air vents 2031 may be arranged in a circumferential direction of the valve core 203 (e.g., a direction A shown in FIG. 17), a continuous annular stopper 2033 or an intermittent annular stopper 2033 may be arranged on an edge of each air vent 2031 to block the valve diaphragm 206 (shown in FIG. 16), which may prevent the valve diaphragm 206 from becoming stuck in the air vent 2031 and failing to rebound during pressing of the valve core 203.

Furthermore, in these embodiments, the valve core 203 may be provided with three baffle plates 2032, the three baffle plates 2032 may be spaced apart in the circumferential direction (i.e., the direction A shown in FIG. 17) to form the air vents 2031, one end of each of the three baffle plates 2032 may be connected to an inner wall of the valve core 203, and the other end thereof may be connected to a third connecting portion 2034. The third connecting portion 2034 may be provided with a through hole 2035, and the connecting rod 2061 passes through the through hole 2035 and may be connected to the valve core 203.

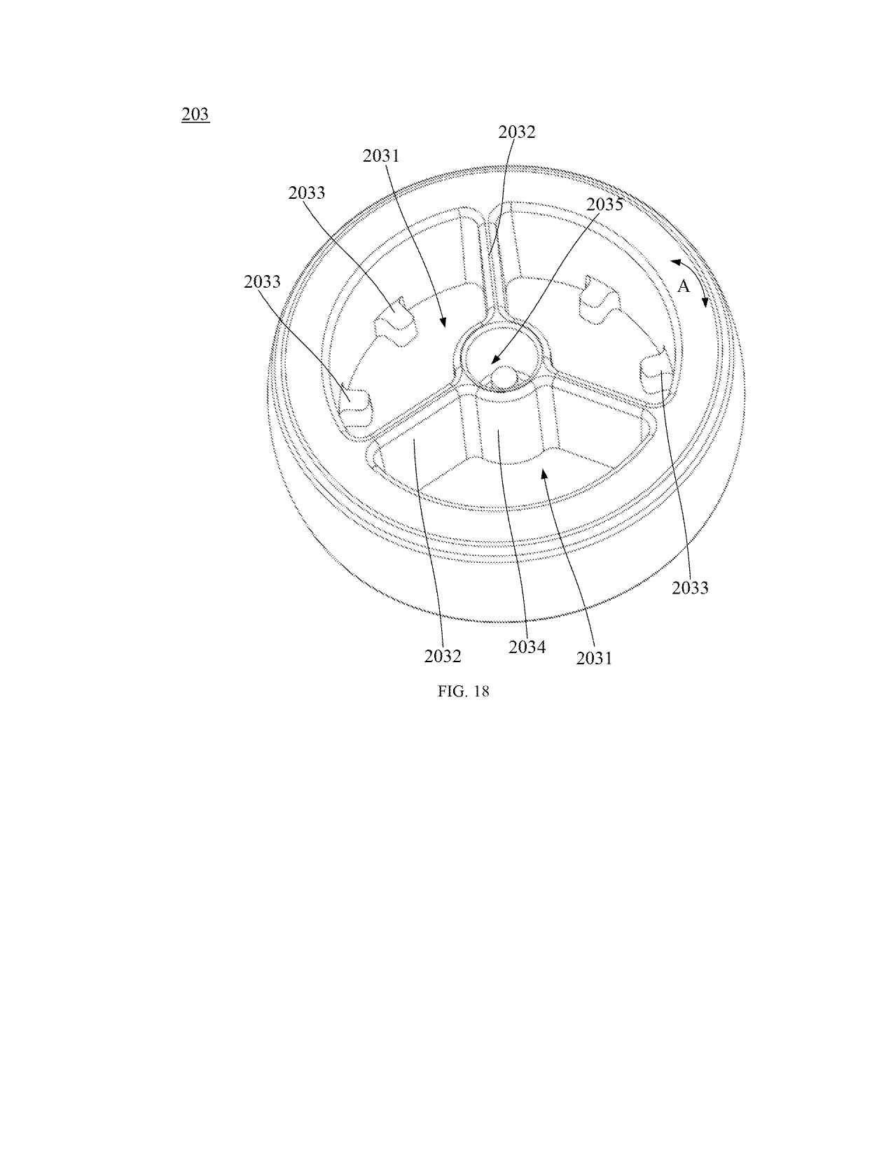

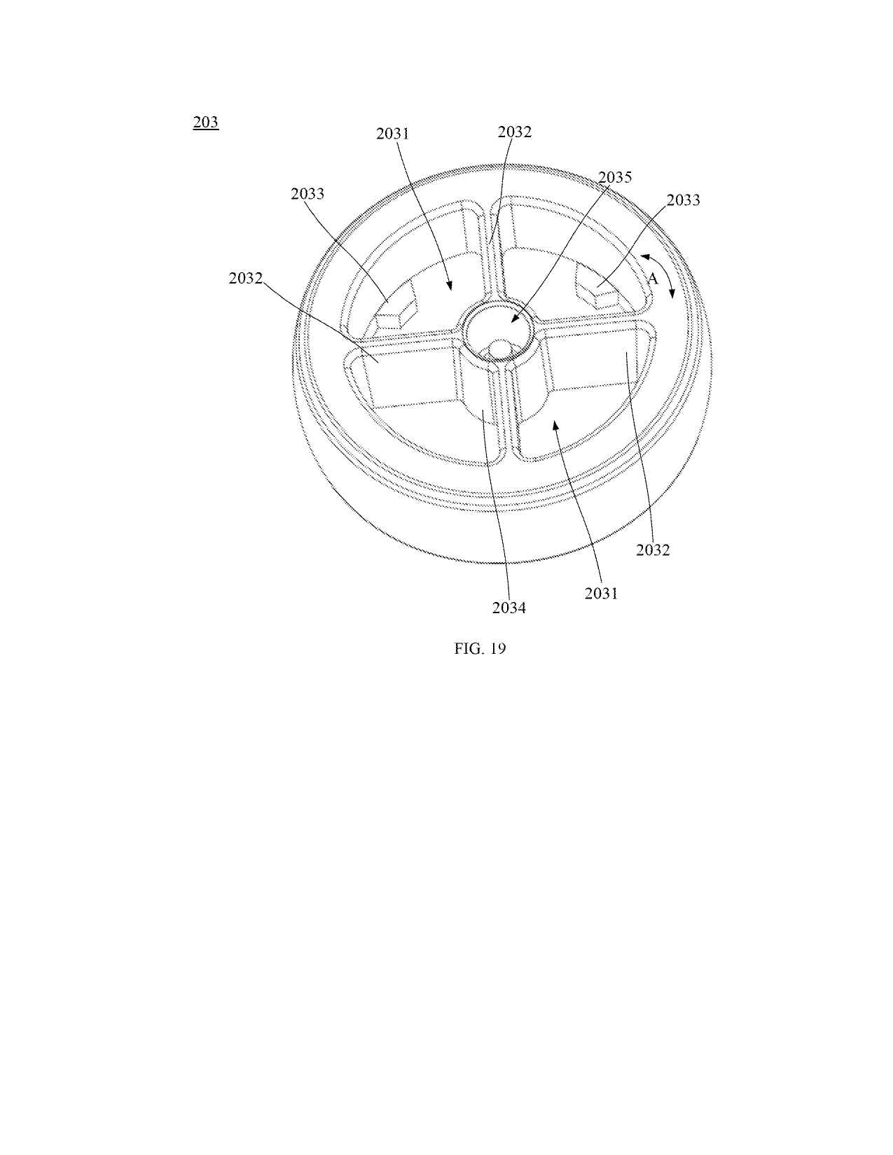

In the embodiments described herein, it should be further appreciated that the stopper 2033 may be integrally formed with the valve core 203 or formed separately from the valve core 203. The stopper 2033 may also be arranged on an edge of the baffle plate 2032, and the stopper 2033 may include any number of stoppers 2033 (e.g., two, three, four, five, etc.) without departing from the scope of the present disclosure. For example, FIG. 18 depicts two separate stoppers being arranged on an edge of each air vent 2031 of the valve core 203, while FIG. 19 depicts that the air vents 2031 may be divided into four parts, and at least one stopper 2033 may be arranged in each air vent 2031 of the valve core 203.

Accordingly, it should be appreciated that the number of stoppers 2033 arranged in the air vent 2031 of the valve core 203 may be not limited, and that the valve core 203 may include any number of stoppers 2033 without departing from the scope of the present disclosure.

Furthermore, the shape of the stopper 2033 is also not limited, and the stopper 2033 may be an integral annular stopper 2033 (e.g., as shown in FIG. 17), or a separate stopper (e.g., as shown in FIGS. 18 and 19), as long as the stopper is configured to block the valve diaphragm 206 from entering the air vent 2031. In particular, it should be appreciated that the stopper 2033 may be in the shape of a protruding point, a rectangle, a circular arc, a triangle, or any other similar shape without departing from the scope of the present disclosure.

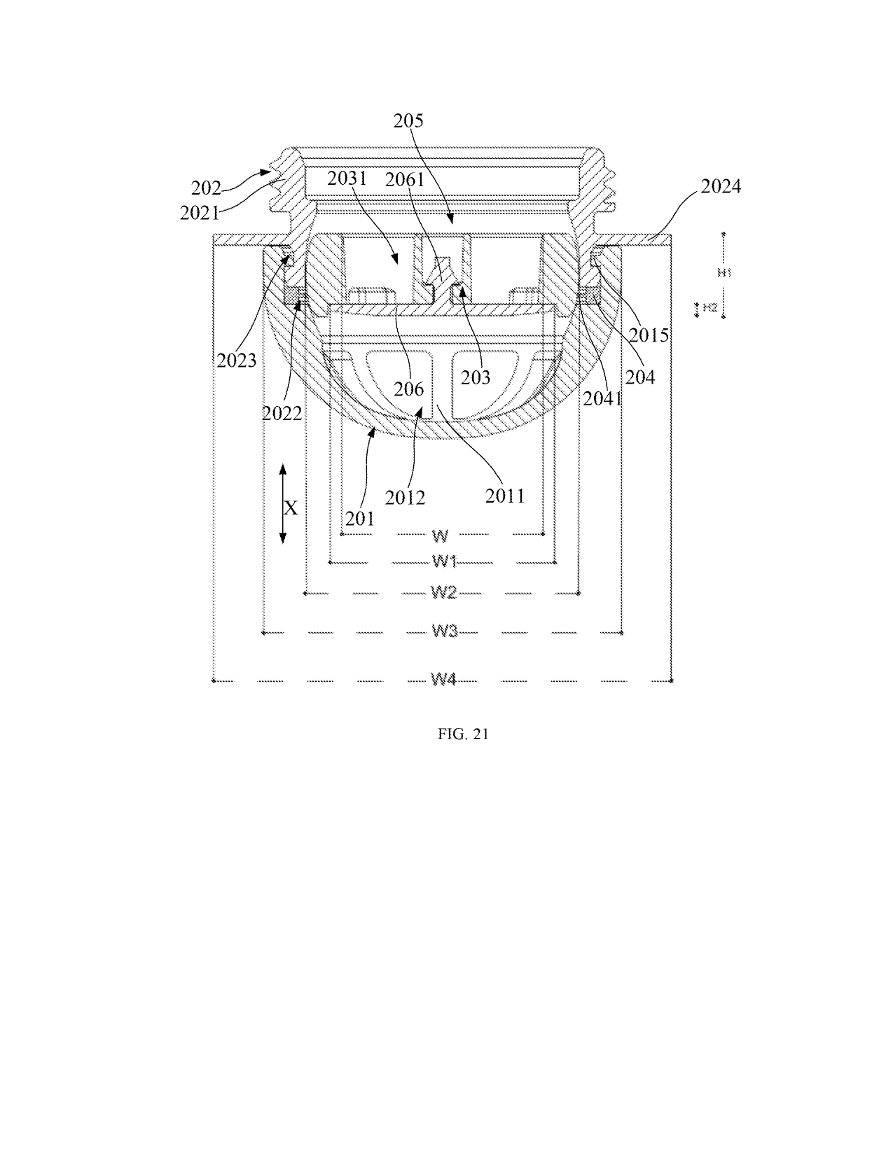

Referring now to FIG. 21, the stopper 2033 may be arranged at a bottom edge of the air vent 2031 or a bottom edge of the baffle plate 2032 in a height H1 direction of the valve core. In some embodiments, the stopper 2033 may also be arranged at the middle or other positions of the air vent 2031 or the baffle plate 2032 in the height direction of the valve core 203, as long as the stopper is configured block the valve diaphragm 206. That is to say, the stopper 2033 may be arranged at the bottom, middle or top of an inner wall of the air vent 2031 in an axial direction (i.e., a direction X shown in FIG. 21) without departing from the scope of the present disclosure.

In the embodiments described herein, the stopper 2033 may extend toward the through hole 2035 with a length of 1.5 mm to 4 mm and extends in the circumferential direction A with a width of 1.5 mm to 4 mm. In some embodiments, the length may be 2 mm, and the width may be 1.5 mm. However, it should be appreciated that the length and width of the stopper 2033 may also be larger or smaller, and such that the stopper 2033 may have any length and/or width without departing from the scope of the present disclosure.

Similarly, it should be understood that the number and shape of the air vents 2031 described above are both not limited. For example, and as described hereinabove, the air vents may be divided into three equal parts (e.g., as shown in FIG. 18), four equal parts by the baffle plates 2032 (e.g., as shown in FIG. 19), or any other number of parts without departing from the scope of the present disclosure.

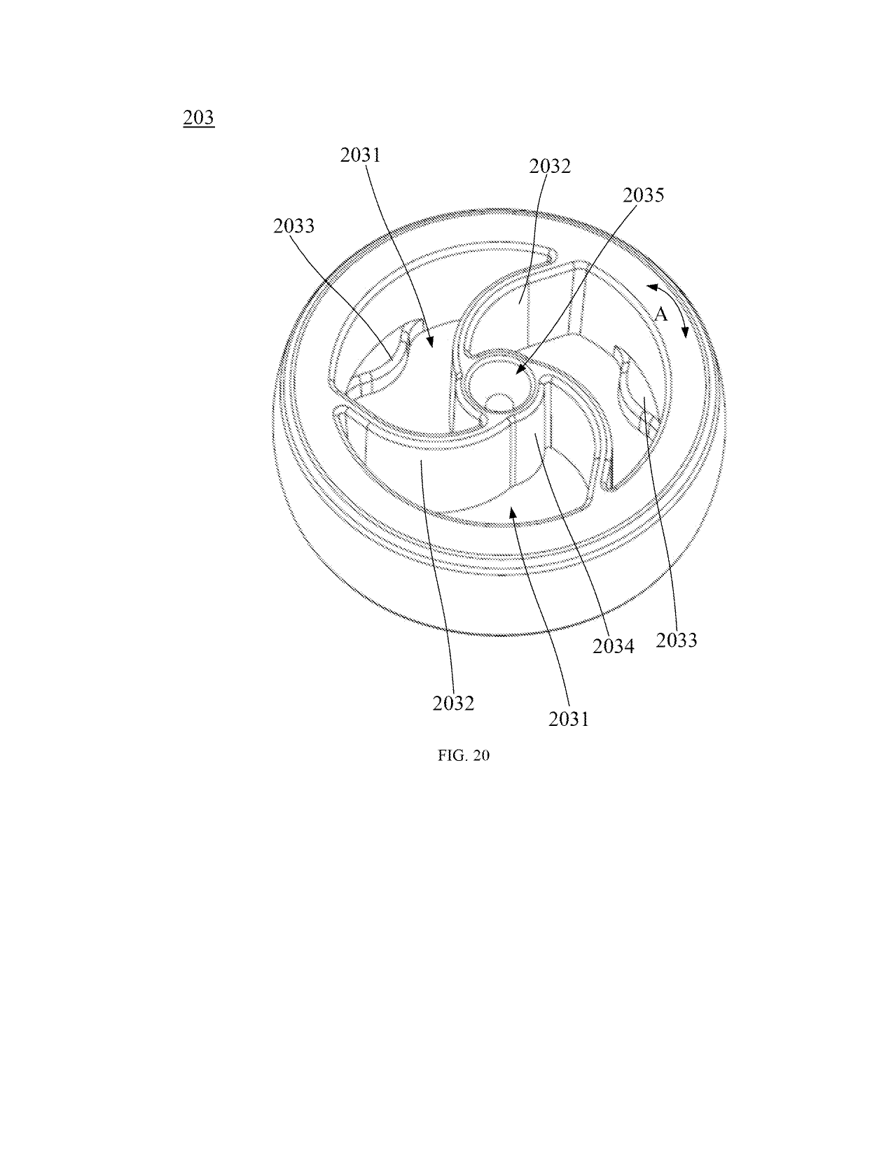

Referring now to FIGS. 19 and 20, an embodiment of the valve core 203 is depicted in additional detail. In these embodiments, the valve core 203 may include a baffle plate 2032, with the baffle plate 2032 being arc-shaped, which may increase the contact area when pressing the valve core and facilitate the pressing of the valve core. Of course, the baffle plate 2032 may also be a straight baffle plate as shown in other embodiments described herein.

As further depicted in FIGS. 19 and 20, in these embodiments, the stopper 2033 may be an annular block, one side of the stopper 2033 may be connected to the inner wall of the air vent 2031, and the other side thereof extends toward the through hole 2035.

Turning now to FIG. 21, a maximum high-frequency outer diameter dimension W4 of the valve seat 202 of the air valve 200 may be set in a range of 40 mm to 120 mm, which may allow the air valve 200 to be operable for use in TPU inflatable sponge mattresses described hereinabove. In these embodiments, the maximum high-frequency outer diameter dimension W4 of the valve seat 202 of the air valve 200 may be 55 mm. However, it should be understood that the maximum high-frequency outer diameter dimension W4 may also be in other value ranges between 40 mm and 120 mm, such as a range of 52 mm to 60 mm, or within any other similar value range. Furthermore, in some embodiments, the maximum high-frequency outer diameter dimension of other valve seats 202 may be substantially about 55 mm; therefore, the dimension W4 may also be 52 mm, 53 mm, 54 mm, 56 mm, 57 mm, 58 mm, 59 mm, or 60 mm or any other similar value without departing from the scope of the present disclosure.

According to the maximum high-frequency outer diameter dimension of the air valve 200, a maximum outer diameter dimension W3 of the valve body 201 of the air valve 200 may be set between 30 mm and 110 mm. In some embodiments, the outer diameter dimension W3 of the valve body 201 of the air valve 200 may be 45 mm. In other embodiments still, the outer diameter dimension W3 of the valve body 201 of the air valve 200 may also be in other ranges between 30 mm and 110 mm, such as a range of 40 mm to 52 mm, or other specific values. For example, the dimension W3 may also be 42 mm, 45 mm, 48 mm, or 52 mm.

According to the maximum high-frequency outer diameter dimension of the air valve 200, a maximum outer diameter dimension W2 of the valve core 203 of the air valve 200 may be set between 20 mm and 100 mm. In some embodiments, the maximum outer diameter dimension W2 of the valve core 203 of the air valve 200 may be 35 mm. In other embodiments still, the maximum outer diameter dimension W2 of the valve core 203 of the air valve 200 may also be in other ranges between 20 mm and 100 mm, such as a range of 30 mm to 42 mm, or other specific values. For example, the dimension W2 may also be 32 mm, 35 mm, 38 mm, or 42 mm.

An outer diameter dimension W1 of the valve diaphragm 206 may be set between 18 mm and 108 mm. In some embodiments, the outer diameter dimension W1 of the valve diaphragm 206 may be 30 mm. In other embodiments still, the outer diameter dimension W1 of the valve diaphragm 206 may also be within other ranges between 18 mm and 108 mm, such as a range of 27 mm to 40 mm, or any other similar range. For example, the dimension W1 may also be 29 mm, 32 mm, 35 mm, 37 mm, or 40 mm. It should be appreciated that the outer diameter dimension W1 may further include any outer diameter without departing from the scope of the present disclosure.

Furthermore, according to a maximum high-frequency outer diameter dimension of the air valve 200, an inner diameter dimension W of the valve core 203 of the air valve 200 may be set between 16 mm and 96 mm, which may maximize the size of the air inlet/outlets. In some embodiments, the maximum inner diameter dimension W of the valve core 203 of the air valve 200 may be 26 mm. In other embodiments, the maximum inner diameter dimension W of the valve core 203 of the air valve 200 may also be within other ranges between 16 mm and 96 mm, such as, a range of 24 mm to 37 mm, or other specific values. For example, the dimension W may also be 26 mm, 29 mm, 32 mm, 34 mm, or 37 mm, or any other similar dimension W without departing from the scope of the present disclosure.

A thickness dimension H1 of the valve core 203 of the air valve 200 may be greater than or equal to 3 mm, and an outer circular arc surface of the valve core 203 and the airflow channel (i.e., the fluid channel 205 described above) composed of the valve seat 202 and the valve body 201 may have a concentric circle structure, such that turning the valve core 203 within the airflow channel (e.g., the fluid channel 205 described above) can be ensured without causing jamming or other similar issues.

The valve diaphragm 206 may have a thickness dimension H2 of 0.5 mm to 10 mm, which may allow the air vent 2031 to move between the open state and the closed state, as described hereinabove, while still meeting the sealing requirements of the valve core 203. In these embodiments, the thickness dimension H2 of the valve diaphragm 206 may be 1.2 mm.

In order to facilitate the operation of the valve core 203 of the air valve by the user, a force required to flip/turn the valve core 203 may be less than 0.5 N, and preferably, 0.1 N, 0.15 N, 0.2 N, 0.25 N, 0.3 N, 0.4 N or 0.45 N.

Although the present disclosure has been illustrated and described with reference to some preferred implementations of the present disclosure, those of ordinary skill in the art should understand that the above contents are further detailed descriptions for the present disclosure with reference to specific implementations, and it cannot be assumed that the specific implementations of the present disclosure are limited to these descriptions. Those skilled in the art can make various changes in form and details, including several simple deduction or substitutions, without departing from the spirit and scope of the present disclosure.

The foregoing descriptions are only embodiments of the present disclosure and are not intended to limit the present disclosure. For those skilled in the art, various changes and variations can be made to the present disclosure. Any modifications, equivalent replacements, and improvements made without departing from the spirit and principle of the present disclosure shall fall within the scope of the claims of the present disclosure.

Furthermore, it should be apparent that the present disclosure is not limited to the details of the above-mentioned exemplary embodiments, and the present disclosure can be implemented in other specific forms without departing from the spirit or basic features of the present disclosure. Therefore, no matter from which point of view, the embodiments should all be regarded as exemplary and non-limiting. The scope of the present disclosure is defined by the appended claims rather than the above-mentioned description, and therefore it is intended that all changes which fall within the meaning and range of equivalents of the claims are embraced in the present disclosure. Any reference signs in the claims should not be construed as limiting the claims involved. In addition, it is apparent that the word "comprise/include" does not exclude other elements or steps, and the singular does not exclude the plural. The terms first, second, etc. are used for designations and do not represent any particular order.

It should be understood that the embodiments as shown in the drawings only show the optional shapes, sizes and arrangements of optional components of the air valve and inflatable products according to the present disclosure, which are merely illustrative but not restrictive, and other shapes, sizes and arrangements may be employed without departing from the idea and scope of the present disclosure.

The technical contents and technical features of the present disclosure are disclosed above, but it can be understood that those skilled in the art would have made various variations and improvements to the concepts disclosed above under the creative idea of the present disclosure, and all the variations and improvements fall into the scope of protection of the present disclosure. The descriptions of the above embodiments are illustrative but not restrictive, and the scope of protection of the present disclosure is determined by the claims.

1. An air valve comprising:
a valve body;
a valve seat connected to the valve body to form a fluid channel;
a first sealing member arranged between the valve body and the valve seat; and
a valve core comprising air vents in communication with the fluid channel, the valve core being rotatably arranged in the fluid channel relative to the valve seat and being surrounded by the first sealing member, so as to switch the valve core between a first position and a second position,
wherein, in the first position, the valve core is in contact with an inner wall of the fluid channel, and the first sealing member is in contact with the valve core and seals the valve core against the inner wall of the fluid channel; and
in the second position, the valve core is spaced apart from the inner wall of the fluid channel, and the first sealing member surrounds the valve core and is spaced apart from the valve core.

2. The air valve of claim 1, wherein at least one rib is disposed on a side of the first sealing member facing the valve core, and the at least one rib is spaced apart in a circumferential direction, wherein in the first position, the at least one rib abuts against the valve core; and
in the second position, the at least one rib surrounds the valve core and is spaced apart from the valve core.

3. The air valve of claim 1,wherein an inner wall of the valve body protrudes to form a first connecting portion, and the valve seat comprises a first main body portion, wherein the first main body portion is internally hollow and is connected to the valve body to form the fluid channel, the first main body portion extends in an axial direction, such that the first main body portion and the first connecting portion are arranged opposite each other and spaced apart in the axial direction and form an accommodating space together with the inner wall of the valve body, and the first sealing member is located in the accommodating space.

4. The air valve of claim 3, wherein a hook is disposed at a top end of the inner wall of the valve body in the axial direction, the hook and the first connecting portion are spaced apart in the axial direction, a mounting portion is disposed on an outer wall of the first main body portion, and the mounting portion is configured for connection to the hook in a snap-fit manner to connect the valve seat to the valve body and clamp the first sealing member in the accommodating space.

5. The air valve of claim 3, wherein an outer periphery of the first main body portion protrudes outwardly to form a first abutting portion, and the first abutting portion is configured for connection to an inflatable main body.

6. The air valve of claim 5, wherein the first abutting portion is annular.

7. The air valve of claim 3, wherein an outer periphery of the first main body portion protrudes outwardly to form a second abutting portion, the second abutting portion axially extends in a direction close to the valve body and is spaced apart from the first main body portion in a radial direction to form an annular groove, and the annular groove is configured to accommodate the valve body and is in threaded fit with an outer wall of the valve body to clamp the first sealing member in the accommodating space.

8. The air valve of claim 7, wherein a projection of the second abutting portion in the axial direction comprises a first straight segment, a first circular arc segment, a second straight segment, a third straight segment, a second circular arc segment and a fourth straight segment that are connected to each other.

9. The air valve of claim 3, wherein a plurality of supports are disposed on a side of the valve body away from the valve seat, the plurality of supports are spaced apart in a circumferential direction to form a plurality of air outlet through holes, and the plurality of air outlet through holes are in communication with the fluid channel.

10. The air valve of claim 9, wherein one end of each of the plurality of supports extends toward the valve seat and is connected to the first connecting portion, the other end of each of the plurality of supports is connected by means of a second connecting portion, and the second connecting portion is located at a bottom end of the valve body.

11. The air valve of claim 1, further comprising a valve cap threadedly connected to the valve seat.

12. The air valve of claim 11, wherein the valve cap comprises a first portion and a second portion, the first portion and the second portion being spaced apart in a radial direction to form a connecting groove, and the connecting groove being configured to accommodate the valve seat and being threadedly connected to the valve seat.

13. The air valve of claim 12, wherein the first portion is internally hollow and is in communication with the fluid channel, a plurality of reinforcing ribs are disposed inside the first portion, and the plurality of reinforcing ribs are spaced apart in a circumferential direction.

14. The air valve of claim 12, wherein a second sealing member is disposed in the connecting groove to enable a sealed connection between the valve cap and the valve seat.

15. The air valve of claim 1, wherein the valve core comprise a plurality of baffle plates, the plurality of baffle plates are spaced apart in a circumferential direction to form the air vents, one end of each of the plurality of baffle plates is connected to an inner wall of the valve core, and the other end of each of the plurality of baffle plates is connected to a third connecting portion.

16. The air valve of claim 1, wherein at least a part of an inner wall of each air vent comprises a stopper, and the stopper extends toward the air vent.

17. The air valve of claim 16, wherein the stopper is an annular block, one side of the stopper is connected to the inner wall of the air vent, and the other side of the stopper extends toward the air vent.

18. The air valve of claim 1, wherein the valve core is capable of 360-degree omnidirectional rotation within the fluid channel, enabling unrestricted multi-axis movement centered at a central axis of the valve core.

19. An air valve comprising:
a valve body;
a valve seat connected to the valve body to form a fluid channel;
a valve core comprising air vents in communication with the fluid channel, the valve core being rotatably arranged in the fluid channel relative to the valve seat to switch the valve core between a first position and a second position
a first sealing member surrounding the valve core and integrally formed with the valve core,
wherein in the first position, the valve core is in contact with an inner wall of the fluid channel, and the first sealing member is in contact with the inner wall of the fluid channel and seals the valve core against the inner wall of the fluid channel; and
in the second position, the valve core is spaced apart from the inner wall of the fluid channel, and the first sealing member is spaced apart from the inner wall of the fluid channel.

20. An air valve assembly comprising:
an air valve comprising:
a valve body;
a valve seat connected to the valve body to form a fluid channel;
a valve core comprising air vents in communication with the fluid channel, the valve core being rotatably arranged in the fluid channel relative to the valve seat to switch the valve core between a first position and a second position; and
a sealing member surrounding the valve core; and
a connector comprising a connector body including a first end and a second end that are arranged opposite each other in an axial direction, the first end being provided with a recess for abutting against an external apparatus, and the second end being provided with a thread and being threadedly connected to the valve seat;
wherein in the first position, the valve core is in contact with an inner wall of the fluid channel, and the sealing member is in contact with the inner wall of the fluid channel and seals the valve core against the inner wall of the fluid channel; and
in the second position, the valve core is spaced apart from the inner wall of the fluid channel, and the sealing member is spaced apart from the inner wall of the fluid channel.
